(19) United States
(12) Patent Application Publication
(10) Pub. No.: US 2021/0154878 A1
(43) Pub. Date: May 27, 2021

(54) PUNCHING DEVICE

(71) Applicant: DUPLO CORPORATION, Sagamihara-shi (JP)

(72) Inventors: Tomio HONMA, Sagamihara-shi (JP); Isamu MISHIMA, Sagamihara-shi (JP); Yo OHAMA, Sagamihara-shi (JP)

(21) Appl. No.: 17/104,917

(22) Filed: Nov. 25, 2020

(30) Foreign Application Priority Data
Nov. 25, 2019 (JP) 2019-212633
May 19, 2020 (JP) 2020-087654

(51) Int. Cl. B26F 1/40; B26F 1/44; B26D 5/34

(52) U.S. Cl. CPC B26F 1/40; B26D 5/34; B26F 1/44

(57) ABSTRACT

A die cutter including: a moving platen and a fixed platen; a moving mechanism structured to cause the moving platen to vertically move toward the fixed platen; and a controller structured to control the moving mechanism, wherein the die cutter punches a sheet material with a punching die attached to the fixed platen by bringing the moving platen closer to the fixed platen using the moving mechanism, and the moving mechanism includes: four lift transmission mechanisms structured to pressurize the moving platen upwardly with four pressurizers having different positions in a horizontal direction from one another; and four press motors structured to drive the lift transmission mechanisms, respectively.

### BACKGROUND OF THE INVENTION

### 1. Field of the Invention

The present invention relates to a punching device.

### 2. Description of the Related Art

Conventionally, a punching device, including: a moving platen and a facing platen that are vertically disposed to face each other; a moving mechanism that causes the moving platen to vertically move toward the facing platen; and a control unit that controls the moving mechanism, wherein the punching device punches a workpiece into a predetermined shape by a punching die attached to at least one of the moving platen and the facing platen by bringing the moving platen closer to the facing platen using the moving mechanism, is known.

As this type of punching device, a punching device, in which the moving mechanism includes a link mechanism, and the crankshaft of the link mechanism is rotationally driven, so that the link mechanism pushes up the lower movable platen and a workpiece between the lower movable platen and the upper fixed platen is punched by a punching die, is described in JP 2011-136394 A.

### SUMMARY OF THE INVENTION

In a punching device in which a moving platen moves toward a facing platen, the punching pressure, which is the force that presses the workpiece toward the punching die, becomes uneven due to the arrangement of the cutting blades of the punching die, the manufacturing error of the punching die, and the like, and in places where the punching pressure is low, the punching blade may not punch through the workpiece, resulting in uneven punching.

The punching device of JP 2011-136394 A includes a punching pressure adjusting mechanism that adjusts the punching pressure by adjusting the vertical positions of the lower ends of the link mechanisms on the sheet inlet side and the sheet outlet side where the sheet, which is a workpiece, enters and exits.

However, the punching device of JP 2011-136394 A includes a drive source that drives the punching pressure adjusting mechanism in addition to a drive source of the moving mechanism that moves the moving platen for punching. The drive source of this punching pressure adjusting mechanism is a drive source dedicated to punching pressure adjustment, which is stopped when punching is performed and does not contribute to obtaining the punching pressure required for punching.

In order to solve the above-mentioned problems, the present invention is a punching device, including: a moving platen and a facing platen that are vertically disposed to face each other; a moving mechanism that causes the moving platen to vertically move toward the facing platen; and a control unit that controls the moving mechanism, wherein the punching device punches a workpiece into a predetermined shape by a punching die attached to at least one of the moving platen and the facing platen by bringing the moving platen closer to the facing platen using the moving mechanism, and the moving mechanism includes: a plurality of pressurizing mechanisms that pressurize the moving platen toward the facing platen with a plurality of pressurizers having different positions in a horizontal direction from one another, respectively; and a plurality of drive sources that drive the plurality of pressurizing mechanisms, respectively.

Another aspect of the present invention is a punching method. This method is a punching method for punching a workpiece into a predetermined shape with a punching die attached to at least one of a moving platen and a facing platen by bringing the moving platen closer to the facing platen that is vertically arranged to face the moving platen, the punching method including: pressurizing the moving platen toward the facing platen by a plurality of pressurizers having different positions in a horizontal direction from one another, respectively.

According to the present invention, there is an excellent effect that the punching pressure can be adjusted without providing a drive source dedicated to the punching pressure adjustment, which does not contribute to obtaining the punching pressure required for punching.

### BRIEF DESCRIPTION OF THE DRAWINGS

FIG. 1 is a schematic perspective view of a die-cut system;

FIG. 2 is a front view of a die cutter;

FIG. 3 is an upstream side view of the die cutter;

FIG. 4 is a downstream side view of the die cutter;

FIG. 5 is a front view of the die cutter with a front frame and a back frame hidden;

FIG. 6 is a rear view of the die cutter with the front frame and the back frame hidden;

FIG. 7 is a perspective view of the die cutter with the front frame and the back frame hidden;

FIG. 8 is a schematic view of the upstream side of the die cutter;

FIG. 9 is a block diagram of the die cutter;

FIGS. 10A to 10C are schematic explanatory views of a lift transmission mechanism;

FIGS. 11A to 11C are explanatory views showing displacements of a lift transmission rod and a columnar portion when the lift transmission mechanism is driven such that the columnar portion moves from bottom dead center to top dead center;

FIG. 12 is an explanatory view of a punching height adjustment screen;

FIG. 13 is an explanatory perspective view of a leveling jig;

FIGS. 14A and 14B are a top view and a front view of the leveling jig;

FIGS. 15A and 15B are explanatory diagrams showing a difference in displacement of the eccentric shaft portion due to the difference of the rotation position of the eccentric shaft;

FIG. 16 is a schematic diagram of the upstream side of the die cutter having appended a belt support mechanism;

FIGS. 17A and 17B are front views of a transport belt pair;

FIGS. 18A to 18C are rear views of a transport belt pair and a moving platen;

FIGS. 19A and 19B are schematic views of the front of the die cutter; and

FIGS. 20A to 20C are explanatory views of a die cutter during transportation of a sheet material.

### DETAILED DESCRIPTION OF THE INVENTION

Hereinafter, the same or equivalent components, members, and processes shown in each drawing shall be designated by the same reference numerals, and duplicate description will be omitted as appropriate. In addition, the dimensions of the members in each drawing are shown enlarged or reduced as appropriate for easy understanding. In addition, some of the members that are not important for explaining the embodiment in each drawing are omitted.

Hereinafter, an embodiment of a punching device according to the present invention and a punching processing system provided with the punching device will be described.

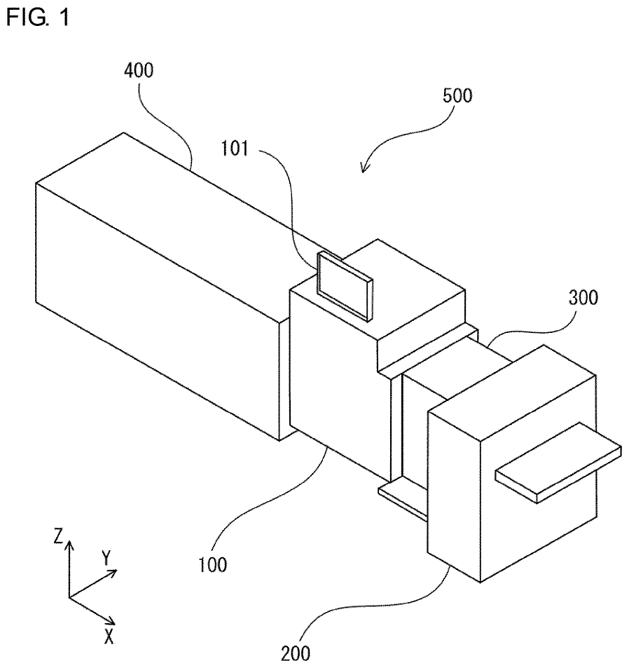

FIG. 1 is a schematic perspective view of a die-cut system 500, which is a punching processing system according to the present embodiment.

The die-cut system 500 includes a sheet feeder 200, a registration device 300, a die cutter 100, and a discharge processing device 400 from the upstream side in the transport direction of the sheet material that is a workpiece.

In the die-cut system 500, the sheet feeder 200, which is a unit for supplying the workpiece, supplies the sheet material placed on the mounting shelf to the registration device 300. The registration device 300 that is a workpiece position correction unit adjusts the inclination of the sheet material with respect to a direction parallel to the transporting direction of the sheet material (in the X-axis direction in the drawing) and the position of the sheet material in the width direction (in the Y-axis direction in the drawing) and transport the sheet material toward the die cutter 100. The die cutter 100, which is a punching unit, temporarily stops the sheet material supplied from the registration device 300, and sandwiches the sheet material between the fixed platen and the moving platen, which will be described in detail later, so that the process of punching the sheet material into the shape of the punching die attached to the fixed platen is performed. The discharge processing device 400 includes a discharge unit that receives the sheet material that has been punched by the die cutter 100 and discharged, a separator that separates the punched sheet material into a product portion and a nonproduct portion, and a stacker that collects separated product portion.

As shown in FIG. 1, the die cutter 100 includes an operation panel 101 on its upper surface.

Next, the die cutter 100 will be described.

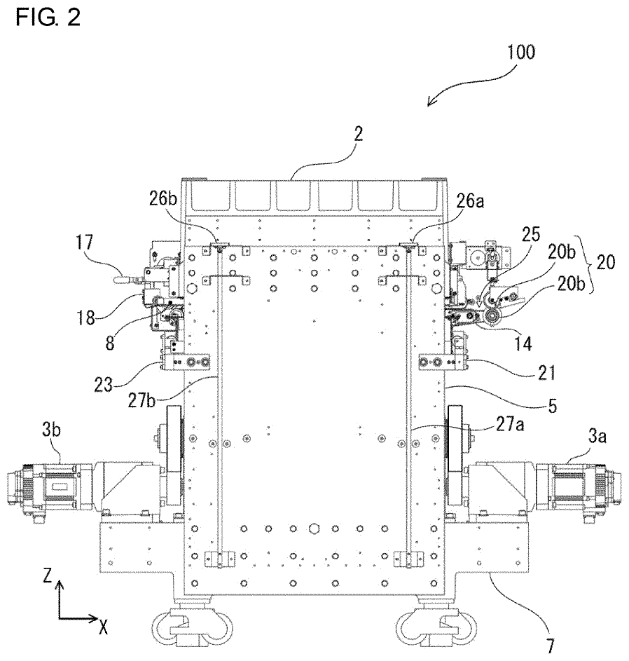

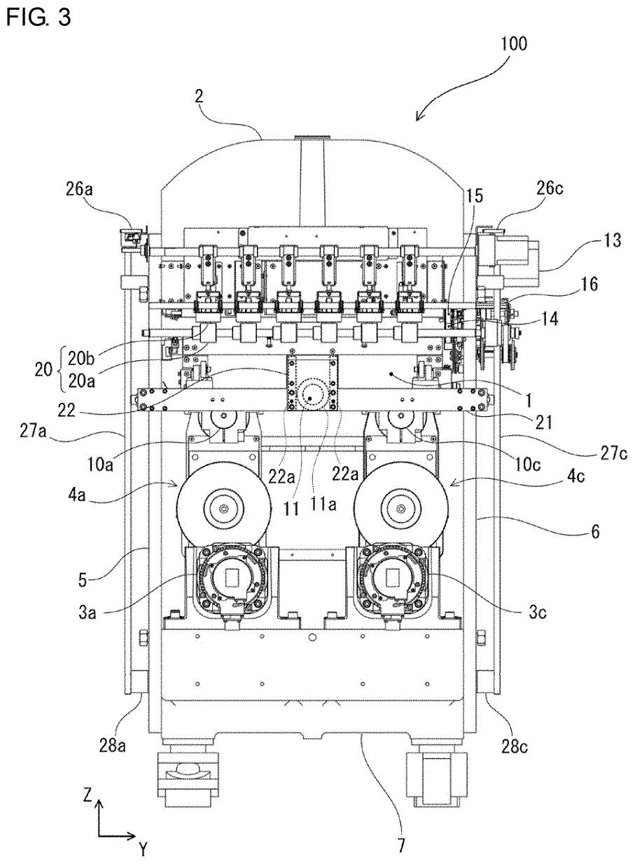

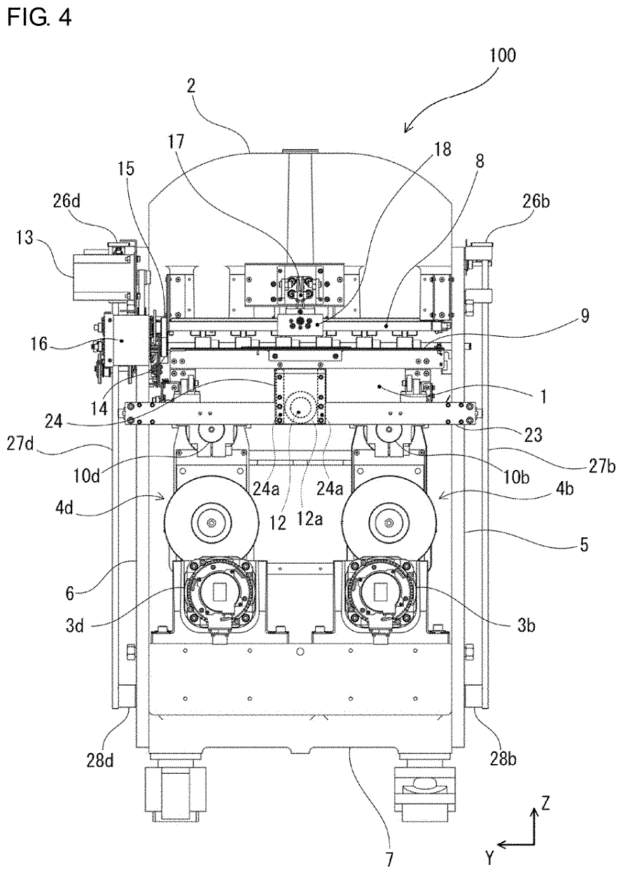

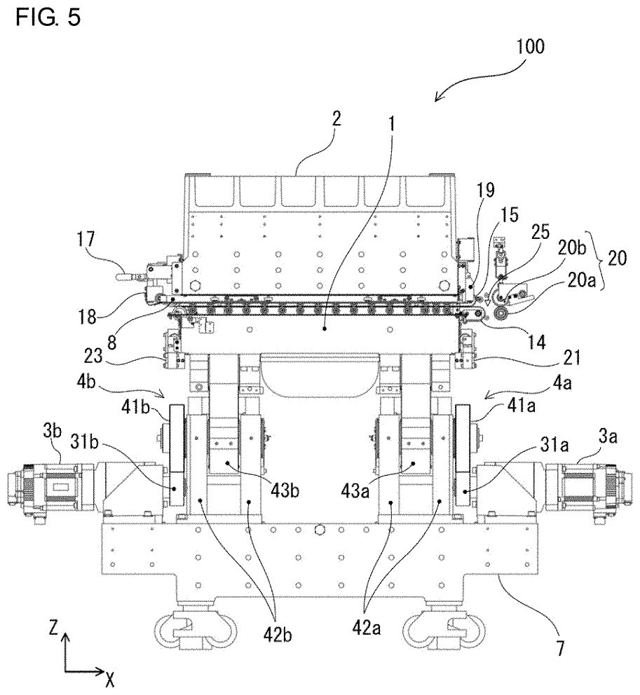

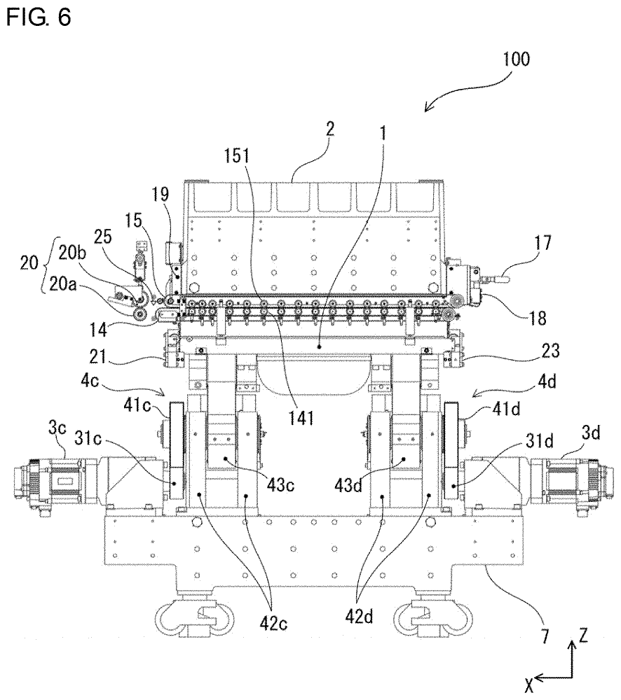

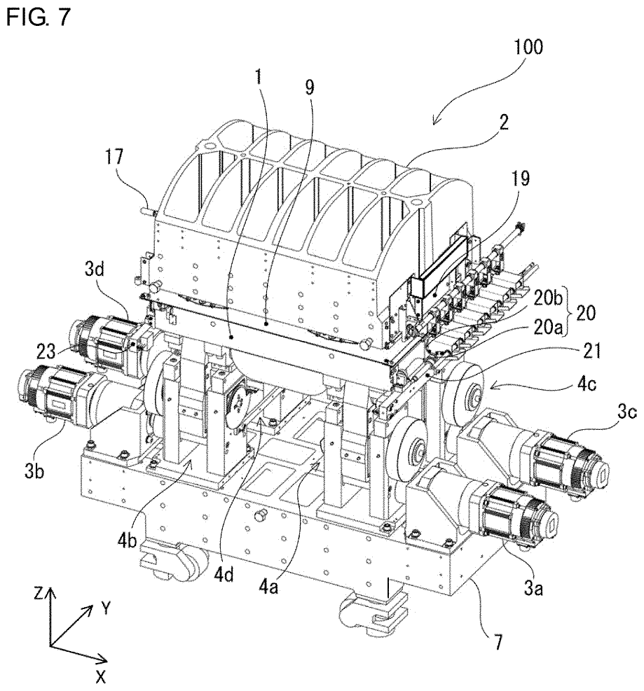

FIGS. 2 to 7 are explanatory views of the die cutter 100 in a state of detaching the outer cover. FIG. 2 is a front view of the die cutter 100. FIG. 3 is an upstream side view of the die cutter 100 seen from the right side in FIG. 2, and FIG. 4 is a downstream side view of the die cutter 100 seen from the left side in FIG. 2. FIG. 5 is a front view of the die cutter 100 in which the front frame 5 and the back frame 6 are hidden from the front view of FIG. 2, and FIG. 6 is a rear view of the die cutter 100 in which the front frame 5 and the back frame 6 in the state shown in FIG. 5 are hidden. In addition, FIG. 7 is a perspective view of the die cutter 100 in which the front frame 5 and the back frame 6 are hidden.

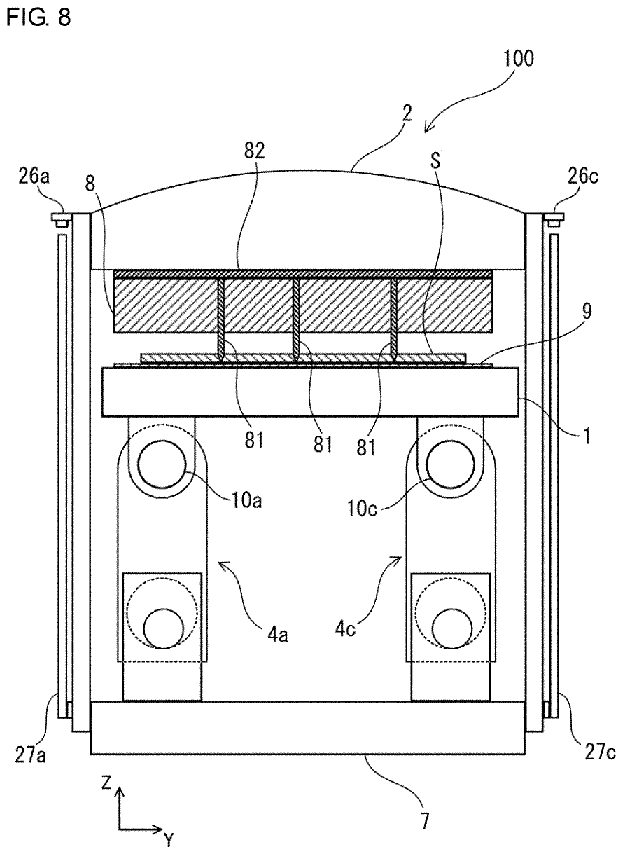

FIG. 8 is an explanatory view schematically showing an upstream side view of the die cutter 100 shown in FIG. 3.

As shown in FIGS. 2 to 7, the die cutter 100 includes a moving platen 1 that can move up and down with respect to the frame (5, 6, 7, etc.) of the device, and a fixed platen 2 that is arranged above and face the moving platen 1 to be fixed to the frame of the device.

The die cutter 100 includes a gantry frame 7, a front frame 5, a back frame 6, an upstream guide frame 21, and a downstream guide frame 23 as a metal frame structure. The gantry frame 7 has casters for movement and a movement prevention fixing mechanism. The front frame 5 and the back frame 6 are plate-shaped members, and the lower portions thereof are fixed to the gantry frame 7. The upstream guide frame 21 and the downstream guide frame 23 are square bar-shaped members extending in the width direction of the device and having both ends fixed to the front frame 5 and the back frame 6.

The fixed platen 2 is fixed to the upper part of the front frame 5 and the back frame 6. In addition, as shown in FIG. 8, the punching die 8 having the cutting blade 81 is fixed to the lower surface of the fixed platen 2 with the stainless plate 82 interposed therebetween. On the other hand, the counter plate 9 is fixed to the upper surface of the moving platen 1.

The die cutter 100 includes four lift transmission mechanisms 4 (4a, 4b, 4c, 4d) and four press motors 3 (3a, 3b, 3c, 3d) as a moving mechanism for vertically moving the moving platen 1. The moving platen 1 has four columnar portions 10 (10a, 10b, 10c, 10d) fixed in the lower part thereof whose axial direction is parallel to the transport direction. The lift transmission mechanism 4 includes a configuration of a crank mechanism for converting a rotational movement inputted to the reciprocating movement in the vertical direction, and the moving platen 1 moves in the vertical direction by rotationally driving the press motor 3 and the lift transmission mechanism 4 transmitting the lift movement to the columnar portions 10.

FIG. 2 to FIG. 7 are explanatory drawings of a state in which all of four columnar portions 10 are in a state located at the bottom dead center of the lift transmission mechanism 4, and that the moving platen 1 is the farthest from the fixed platen 2 in a movable range of the moving platen 1.

FIG. 8 is an explanatory view of a state in which the moving platen 1 is raised to the upper stop position and the sheet material S is punched out by the cutting blade 81 of the punching die 8.

As shown in FIG. 3, the moving platen 1 includes an upstream side guided shaft 11 protruding to the upstream side in the transport direction in parallel with the X axis in the drawing at the center in the width direction of the surface on the upstream side in the transport direction. In addition, as shown in FIG. 4, the moving platen 1 includes a downstream side guided shaft 12 protruding to the downstream side in the transport direction in parallel with the X axis in the drawing at the central portion in the width direction of the surface on the downstream side in the transport direction. The upstream side guided shaft 11 and the downstream side guided shaft 12 are provided with an upstream side guided bearing 11a and a downstream side guided bearing 12a.

As shown in FIG. 3, an upstream side guide portion 22 is provided at the central portion of the upstream guide frame 21 in the width direction. The upstream side guide portion 22 includes two upstream side guide rails 22a protruding to the downstream side in the transport direction and extending in the vertical direction, and restricts the movement of the upstream side guided shaft 11 in the width direction by engaging so as to sandwich the upstream side guided bearing 11a between the two upstream side guide rails 22a.

In addition, as shown in FIG. 4, a downstream side guide portion 24 is provided at the central portion of the downstream guide frame 23 in the width direction. The downstream side guide portion 24 includes two downstream side guide rails 24a protruding to the upstream side in the transport direction and extending in the vertical direction, and restricts the movement of the downstream side guided shaft 12 in the width direction by engaging so as to sandwich the downstream side guided bearing 12a between the two downstream side guide rails 24a.

By restricting the movement of the upstream side guided shaft 11 and the downstream side guided shaft 12 in the width direction by the upstream side guide portion 22 and the downstream side guide portion 24, the displacement of the moving platen 1 in the width direction at the time when the moving platen 1 moves up and down can be prevented.

The die cutter 100 includes a transport belt pair (14, 15) for transporting the sheet material S on the back side in the width direction with respect to the moving platen 1. In addition, a belt drive motor 13 which is a drive source of the pair of transport belts, and a belt drive transmission mechanism 16 for transmitting a driving force are provided. By driving the belt drive motor 13, the lower transport belt 14 and the upper transport belt 15 move endlessly at the same surface movement speed, and the lower transport belt 14 and the upper transport belt 15 sandwich one end of the sheet material S in the width direction and transport the sheet material S.

In addition, when the belt drive motor 13 is driven, the inlet drive rollers 20a of the inlet roller pair 20 also rotate. The inlet roller pair 20 transports the sheet material S by sandwiching a plurality of locations in the width direction of the sheet material S by the inlet drive roller 20a and the inlet driven roller 20b.

The lower transport belt 14 and the upper transport belt 15 are stretched on a plurality of stretching rollers. The route between the lower transport belt 14 and the upper transport belt 15 is defined such that a part of the stretching roller horizontally forms a surface sandwiching the sheet material S between the upper stretching surface of the lower transport belt 14 and the lower stretching surface of the upper transport belt 15. The stretching roller forming the surface sandwiching the sheet material S is supported by a roller holding member that can move up and down.

When the punching process is performed, the sheet material S is transported to the position between the moving platen 1 and the fixed platen 2, and the lower transport belt 14 and the upper transport belt 15 are stopped. The moving platen 1 includes a protrusion protruding to the back side in the width direction, and has a configuration that when the moving platen 1 rises, the protrusion pushes up the roller holding member and the stretching surface formed by a stretching roller held by the roller holding member is raised together with the moving platen 1. With this, the sheet material S to be processed can be raised toward the fixed platen 2 in accordance with the rise of the moving platen 1.

As a configuration for moving the sheet material S sandwiched between a transport belt pair (14, 15) in the vertical direction, the holding unit that can move up and down may hold the transport belt pair (14, 15) with the belt drive mechanism (belt drive motor 13, belt drive transmission mechanism 16). In this case, it is configured that the holding unit that holds the pair of transport belts including the belt drive mechanism at the protrusion of the moving platen 1 is raised.

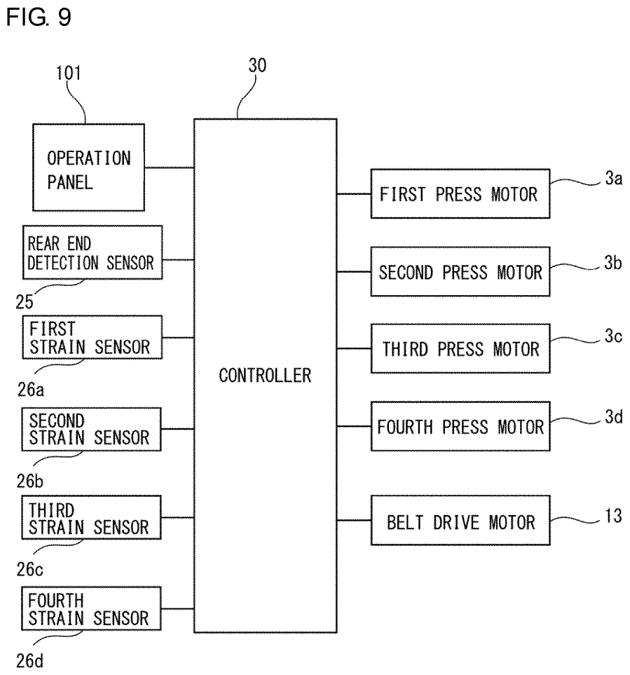

FIG. 9 is a block diagram of the die cutter 100.

The controller 30 of the die cutter 100 controls the drive of the four press motors 3 (3a to 3d) and the belt drive motor 13 based on the output from the operation panel 101 and the rear end detection sensor 25. In the die cutter 100 of the present embodiment, the controller 30 can independently drive and control the four press motors 3 (3a to 3d), respectively.

Next, the preparatory work for performing the punching process will be described.

In the sheet feeder 200, a bundle of sheet materials S to be punched is placed on a mounting shelf.

In the die cutter 100, the punching die 8 is set under the fixed platen 2, and the counter plate 9 is set on the moving platen 1. When setting the punching die 8 and the counter plate 9, the discharge unit provided at the position closest to the die cutter 100 of the discharge processing device 400 is manually or electrically lowered. With this, the exit side of the space between the fixed platen 2 and the moving platen 1 through which the sheet material S passes is opened, and access from the outside becomes possible.

Below the fixed platen 2, a die slide guide capable of sliding the punching die 8 in the direction along the transport direction is provided. The punching die 8 slides along the die slide guide toward the upstream side of the transport direction by inserting the punching die 8 from the downstream side in the transport direction of the device main body to the space below the fixed platen 2. The punching die 8 is inserted until the tip of the punching die 8 in the insertion direction abuts on the die abutting plate 19, and the die fixing lever 17 is pulled down to be in a state shown in FIG. 2, and thereby it is locked in a state where the die fixing member 18 abuts the punching die 8 against the die abutting plate 19 and abuts the punching die 8 against the lower surface of the fixed platen 2. With this, the punching die 8 is fixed to the fixed platen 2.

When an identifier such as a barcode for calling information about the punching die 8 is given to the punching die 8, the punching die 8 is set on the fixed platen 2 after reading the identifier with a reading unit such as a handy scanner.

After setting the punching die 8 and the counter plate 9, the discharge unit is manually or electrically raised to a predetermined position.

Next, the job setting is performed using the operation panel 101 or the external input device. The setting content can include the size of the sheet material S, the height of the cutting blade 81 of the punching die 8, the thickness of the sheet for the punching die 8, the number of times that the punching die 8 had previously punched, the punching die reference position, the sheet reference position and the like.

Here, the thickness of the sheet for the punching die 8 is the sum of the thicknesses of a stainless plate 82 fixed on the upper surface of the punching die 8, the image sheet fixed on the upper surface of the stainless plate 82 and having the arrangement of the cutting blade 81 of the punching die 8 depicted, and the protective sheet covering the upper surface of the image sheet.

The punching die 8 is inserted into and removed from the die cutter 100 in a state in which the stainless plate 82 on the upper surface of the punching die 8, the image sheet to which a shim tape is attached if necessary, and the protective sheet are laminated in this order.

The stainless plate 82 is a member which prevent the cutting blade 81 of the punching die 8 from being raised to the counter plate 9 and protruding from the rear surface (upper surface) of the punching die 8. The image sheet is for allowing for confirming the arrangement of the cutting blade 81 of the punching die 8, and when there is the location where the punching pressure is insufficient, a shim tape for removing unevenness can be kept attached to the upper surface of the image sheet. Since the protective sheet covers and protects the upper surface of the image sheet to which the shim tape for removing unevenness is attached, it is possible to prevent the shim tape for removing unevenness from being rubbed against the lower surface of the fixed platen 2 to be peeled off when it is slid to be set to the punching die 8.

The above-mentioned punching die reference position and sheet reference position are reference values entered in the job setting to ensure that the stop position of the sheet material S during the punching process becomes a stop position in which the position to be punched on the sheet material S and the position of the cutting blade 81 of the punching die 8 match.

The sheet material S stops when a predetermined number of stop pulses is obtained after the rear end detection sensor 25 arranged on the upstream side of the pair of transport belts (14, 15) detects the rear end of the sheet material S, and punching is performed at the stop position.

In the job setting, the operator extracts an arbitrary blade reference point from the cutting blade 81 of the punching die 8, and inputs the punching die reference position which is a distance from the blade reference point to the upstream side end of the punching die 8. In addition, the operator extracts the reference point to be cut corresponding to the above-mentioned blade reference point from the positions to be cut on the sheet material S to be punched, and inputs the sheet reference position which is a distance from the reference point to be cut to the upstream side end of the sheet material S to be punched.

Based on the input punching die reference position and the sheet reference position, the controller 30 calculates the number of stop pulses described above so that the sheet material S stops at a stop position where the blade reference point and the reference point to be cut match. By this process, the cutting blade 81 of the punching die 8 and the position to be cut on the sheet material S at the time of the punching process can be matched.

When the job to be executed by the die cutter 100 includes a creasing process for creasing the sheet material S, the work of fixing the facing recess material for creasing (creasing matrix) to the counter plate 9 is performed. In this work, double-sided tape is attached to the lower surface of the facing recess material for creasing, and the facing recess material for creasing and the clip are attached to the convex portion for creasing provided in the punching die 8. When the creasing recess transfer button is operated in this state, the moving platen 1 moves with a smaller amount of movement than the punching process operation, the counter plate 9 comes into contact with the lower surface of the facing recess material for creasing, and the facing recess material for creasing is pasted to the counter plate 9 with double-sided tape. Since the clip remains in the pasted facing recess material for creasing, the counter plate 9 is removed from the moving platen 1, the clip which is an unnecessary member is removed, and the counter plate 9 is fixed to the moving platen 1.

In the die cutter 100, after the various settings described above, an adjustment process is performed so that appropriate punching can be performed before the mass production process in which the sheet material S is continuously transported and continuously punched.

In the adjustment process, only one sheet material S is fed, and a test feed for punching is performed. In the test feeding, the punching process is performed by the die cutter 100, but the separation process is not performed by the separator, and the product portion of the punching process and the nonproduct portion are discharged to the stacker in a state where they are not separated.

When the operator presses the test feed button on the operation panel 101, the test feed is performed, and the operator sees the product portion of the test feed and adjusts each object. The test feeding and adjustment operations are repeated as needed.

The adjustment operation is performed on the operation panel 101, but may be performed by an external input device.

The objects to be adjusted are the position of the sheet material S in the width direction, the inclination (skew) of the sheet material S with respect to the transport direction, the position of the sheet material S in the transport direction when stopped at the time of punching, and the like. In addition, the die cutter 100 of the present embodiment can also be adjusted by operating the operation panel 101 to correct the uneven punching, as will be described in detail later. The operator visually observes the sheet material S obtained by the test feeding, and performs such an adjustment operation based on the punching misregistration and uneven punching of the sheet material S.

After the adjustment process, the operator inputs the number of sheets to be processed and the processing speed on the operation panel 101, and presses the start button to execute the mass production process. The mass production process is stopped by the processing completion of the input number of processed sheets, the detection of an error, or the operation of the stop button by the operator.

The start button and the stop button may be provided not only on the operation panel 101 but also on the operation unit of the sheet feeder 200 so that they may be operated from either of them.

Next, the operation of the punching process with the die cutter 100 will be described.

When the start button of the operation panel 101 is pressed, the sheet material S is sent from the sheet feeder 200, the inclination and the position in the width direction of the sheet material S are corrected by the registration device 300, and the sheet material S is supplied to the die cutter 100. In the die cutter 100, the belt drive motor 13 is driven, and the lower transport belt 14 and the upper transport belt 15 of the transport belt pair start endless movement. Then, the sheet material S supplied from the registration device 300 is sandwiched between the transport belt pair and transported. The belt drive motor 13 is stopped after a predetermined timing has elapsed after the rear end detection sensor 25 arranged on the upstream side of the transport belt pair detects the rear end of the sheet material S. With this, the sheet material S sandwiched between the transport belt pair is stopped at the punching position between the moving platen 1 and the fixed platen 2.

Next, the four press motors 3 are driven to raise the moving platen 1. When the moving platen 1 rises, the protrusion of the moving platen 1 pushes up the roller holding member described above, and the sheet material S at the transport height also rises. By driving each of the four press motors 3 in the forward rotation by a predetermined amount of rotation and stopping, the moving platen 1 reaches the upper stop position, and the sheet material S is punched into the shape of the cutting blade 81 of the punching die 8.

Next, the four press motors 3 reversely drive by a predetermined amount of rotation and stop, so that the moving platen 1 descends and reaches the lower stop position. At this time, the roller holding member also descends together with the moving platen 1, and the sheet material S descends to the transport height. After that, by restarting the driving of the belt drive motor 13, the punched sheet material S is transported to the discharge processing device 400, and the subsequent sheet material S supplied from the registration device 300 is transported to the punched position as sandwiched between the transport belt pair.

During the mass production process, these operations are repeated.

In the above description, the press motor 3 is driven in the forward direction after the belt drive motor 13 is stopped, and the reverse drive of the press motor 3 is stopped and then the drive of the belt drive motor 13 is restarted, but the motor driving timing is not limited thereto. As long as the sheet material S is not defective in transportation such as jamming, the press motor 3 may be driven in the forward rotation before the belt drive motor 13 is stopped, or the drive of the belt drive motor 13 may be restarted before the reverse drive of the press motor 3 is stopped. By providing a period in which the drive period of the belt drive motor 13 and the drive period of the press motor 3 overlap, the processing speed can be improved.

Next, the movement of the press motor 3 during the punching operation will be described.

When the belt drive motor 13 is driven, the controller 30 controls the rotation position so that the lift transmission mechanism 4 stands by at the lower stop position and the rotation position of the press motor 3 which is a servomotor becomes the lower reference rotation position corresponding to the lower stop position.

After a predetermined timing has elapsed after the rear end detection sensor 25 detects the passage of the rear end of the sheet material S, the belt drive motor 13 is stopped and the press motor 3 starts to rotate in the forward direction. Then, the press motor 3 is rotated in the forward direction to the upper reference rotation position and stopped so that the lift transmission mechanism 4 is in the upper stop position.

When the rotation positions of all four press motors 3 become the upper reference rotation positions and the forward rotation stops, they wait for a predetermined time (20 [msec (milliseconds)]), and then start the reverse rotation. The four press motors 3 stop when they rotate in the reverse direction to the lower reference rotation position.

In this way, the four press motors 3 repeat the forward rotation that rotates from the lower reference rotation position to the upper reference rotation position and the reverse rotation that rotates from the upper reference rotation position to the lower reference rotation position, and thereby performing the punching process.

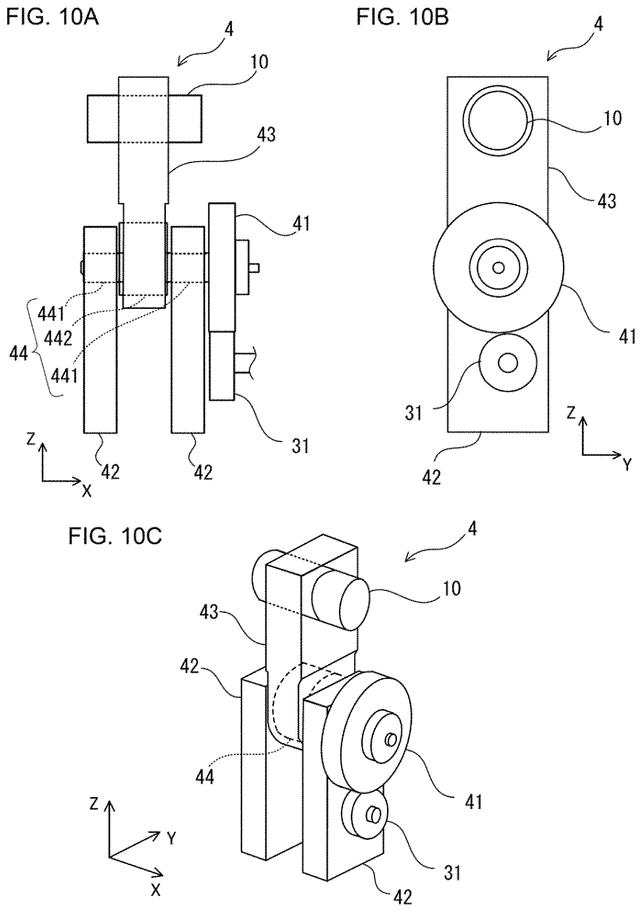

FIGS. 10A to 10C are schematic explanatory views of one of the four lift transmission mechanisms 4. FIG. 10A is an explanatory view in the X-Z plane, FIG. 10B is an explanatory view in the Y-Z plane, and FIG. 10C is a perspective view.

As shown in FIGS. 10A to 10C, the lift transmission mechanism 4 includes a rotary input gear 41 that engages with the rotary output gear 31, an eccentric shaft 44 that rotates together with the rotary input gear 41, and a shaft holder 42 that is fixed to the gantry frame 7 and rotatably holds the rotation shaft portion 441 of the eccentric shaft 44. Furthermore, the lift transmission mechanism 4 includes a lift transmission rod 43 whose lower portion engages with the eccentric shaft portion 442 of the eccentric shaft 44 and whose upper portion engages with the columnar portion 10 of the moving platen 1.

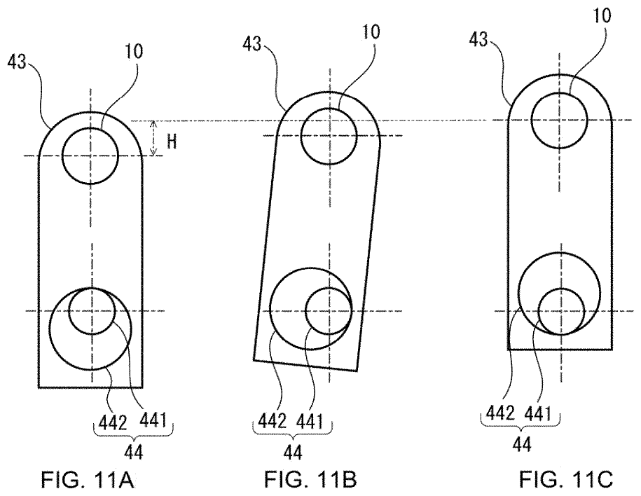

FIGS. 11A to 11C are explanatory views which show the displacement of the lift transmission rod 43 and the columnar portion 10 when the eccentric shaft 44 is rotated around the center line of the rotation shaft portion 441 so that the columnar portion 10 moves from the bottom dead center to the top dead center. FIG. 11A is an explanatory view of a state in which the columnar portion 10 is located at the bottom dead center, and FIG. 11B is an explanatory view of a state in which the columnar portion 10 is located between the bottom dead center and the top dead center, and FIG. 11C is an explanatory view of a state in which the columnar portion 10 is located at the top dead center.

The eccentric shaft 44 is a member whose center line position is different between the rotation shaft portion 441 that engages with the shaft holder 42 and the eccentric shaft portion 442 that engages with the lift transmission rod 43. The position of the center line of the rotary input gear 41 coincides with that of the rotation shaft portion 441.

When the press motor 3 is rotationally driven to rotate the rotary output gear 31, the rotary input gear 41 rotates, and the eccentric shaft 44 to which the rotary input gear 41 is fixed rotates around the center line of the rotation shaft portion 441. With this, the eccentric shaft portion 442 rotates and moves around the central axis of the rotation shaft portion 441, and the lift transmission rod 43 engaging with the eccentric shaft portion 442 and the columnar portion 10 engaging with the lift transmission rod 43 move. At this time, the moving platen 1 having the columnar portion 10 is restricted from moving in the width direction (horizontal direction in FIGS. 11A to 11C, direction parallel to the Y axis) by the upstream side guide portion 22 and the downstream side guide portion 24, and the columnar portion 10 also does not move in the width direction. Thus, when the eccentric shaft portion 442 is displaced in the vertical direction and the width direction due to the rotation of the eccentric shaft 44, as shown in FIG. 11B, the lift transmission rod 43 is tilted and the columnar portion 10 moves only in the vertical direction.

The eccentric shaft 44 of the present embodiment has an eccentric amount of 15 [mm] between the central shaft of the rotation shaft portion 441 and the central shaft of the eccentric shaft portion 442. Thus, the vertical movable range H, which is the displacement amount of the columnar portion 10 when the eccentric shaft 44 is rotated from the state of the bottom dead center shown in FIG. 11A to the state of the top dead center shown in FIG. 11C, is 30 [mm].

The moving mechanism for moving the moving platen 1 has four lift transmission mechanisms 4 (4a to 4d) as a plurality of pressurizing mechanisms that independently pressurize the four columnar portions 10 as a plurality of pressurizers, and four press motors 3 (3a to 3d) as a plurality of drive sources for driving each of them.

Since the controller 30 can independently control the drive of each of the four press motors 3, the upper reference rotation position corresponding to the upper stop position can be changed for each press motor 3. With this, the height of the columnar portion 10 at the upper stop position can be changed individually.

In the die cutter 100 of the present embodiment, the eccentric shaft 44 is not controlled to rotate once, and the columnar portion 10 is controlled to move back and forth between the lower stop position and the upper stop position, which is the range sandwiched between the bottom dead center and the top dead center.

Regarding the rotation angle θ of the eccentric shaft 44, if θ=0[°] when the columnar portion 10 is at the bottom dead center, then θ=180[°] when the columnar portion 10 is at the top dead center. Here, assuming that the rotation angle of the eccentric shaft 44 when the columnar portion 10 is in the lower stop position is θ1 and the rotation angle when the columnar portion 10 is in the upper stop position is θ2, the following equation (1) holds.

0[°]≤θ1<θ2<180[°] (1)

By making the rotation angle of the upper stop position smaller than the rotation angle of the top dead center in this way, it is possible to change the rotation angle “θ2” when the columnar portion 10 is in the upper stop position, and it is possible to adjust the position of the columnar portion 10 when it is in the upper stop position.

When pressurizing, the four press motors 3 in the lower reference rotation position corresponding to the state in which the columnar portion 10 is located in the lower stop position, which is the home position of the lift transmission mechanism 4, are rotated in the forward direction at the same speed. Then, the press motor 3 that has rotated to the upper reference rotation position corresponding to the upper stop position of the lift transmission mechanism 4 is sequentially stopped. When “θ2” of the four press motors 3 are different from each other, the press motor 3 having a large amount of rotation from the lower reference rotation position to the upper reference rotation position has a later stop timing than the other press motors 3.

In contrast, the rotation amounts from the lower reference rotation position to the upper reference rotation position are calculated, respectively, and the rotation speed of the press motor 3 having a larger rotation amount may be increased so that the drive time from the lower reference rotation position to the upper reference rotation position is the same for all the press motors 3.

When the rotation amounts at the upper reference rotation positions are different between the press motors 3, the rotation amounts at the lower reference rotation positions may be set so that the number of rotation up to the upper reference rotation position are the same. With this, even if the rotation amounts of the upper reference rotation positions differ between the press motors 3, the drive time and rotation speed from the lower reference rotation position to the upper reference rotation position can be set to the same value. Then, in the punching operation, it is not necessary to lengthen the drive time or slow down the rotation speed of some press motors 3, and the time required for the punching operation can be shortened. The setting of the rotation amount of the lower reference rotation position may be automatically calculated by the controller 30 or may be input by the user.

As described above, in the die cutter 100 of the present embodiment, the upper reference rotation position corresponding to the upper stop position can be changed for each press motor 3, and the height of the columnar portion 10 at the upper stop position can be individually changed.

With such a configuration, by making a change to increase the amount of rotation of one press motor 3 at the upper reference rotation position, the value of the rotation angle “θ2” of the eccentric shaft 44 at the upper reference rotation position becomes large, and the position of the columnar portion 10 at the upper stop position becomes higher. With this, the punching pressure, which is the abutting pressure between the counter plate 9 and the punching die 8 during the punching process, can be increased vertically above the columnar portion 10 whose position is higher when the upper stop position is reached.

In this way, in a configuration in which the abutting pressure between the counter plate 9 and the punching die 8 during the punching process can be partially increased, it is possible to make a correction for eliminating uneven punching by increasing the rotation amount of the upper reference rotation position of the press motor 3 so that the upper stop position of the columnar portion 10 below the portion where the uneven punching occurs during the test feeding becomes higher.

That is, the punching pressure adjusted by pasting a shim tape for removing unevenness on the back of the punching die with a conventional die cutter can be adjusted by changing the rotation amount of the upper reference rotation position of the press motor 3

For example, when uneven punching occurs on the front upstream side of the sheet material S output by the test feed, the rotation amount of the upper reference rotation position of the first press motor 3a is set to be increased. With this, the value of the rotation angle “θ2” of the eccentric shaft 44 of the first lift transmission mechanism 4a becomes large, and the position of the first columnar portion 10a at the upper stop position can be made higher than before the setting. Then, the punching pressure on the front upstream side of the sheet material S during the punching process can be increased, and the uneven punching can be eliminated.

When correcting the uneven punching on the operation panel 101, the four corners are shown on the operation panel 101, the operator selects the corner for which the punching pressure is to be changed, and a screen for changing the punching pressure of the corner is displayed.

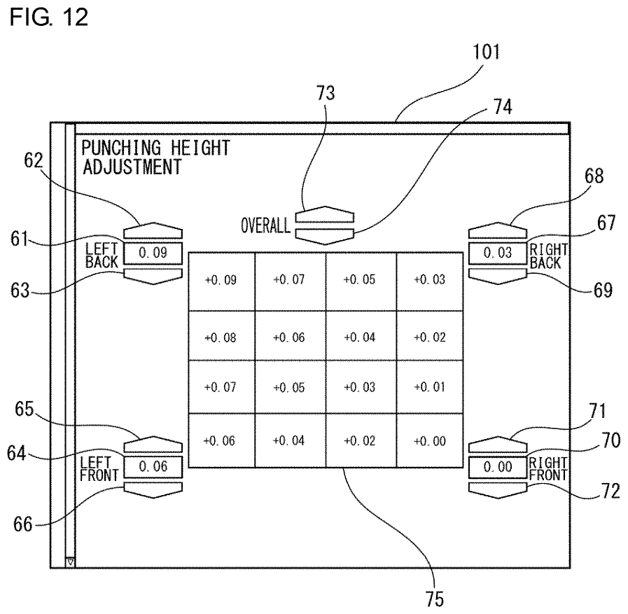

FIG. 12 is an explanatory view of a display screen (punching height adjustment screen) of the operation panel 101 of the “punching height adjustment” that corrects the uneven punching on the operation panel 101.

The punching height adjustment is used when adjusting the pressurization amount of the part where the punching is insufficient for the product portion that has been subjected to the test feeding. In the present embodiment, since the rotation amounts of the four press motors 3 can be adjusted, the punching heights are variable at the four corners.

In the display screen shown in FIG. 12, the punching height distribution display 75 is located at the center thereof.

At the lower right of the punching height distribution display 75, there is a right front punching height adjustment value display window 70 that shows the adjusted value of the first press motor 3a, and in the upper and lower parts thereof, it has a right front punching height up button 71 for raising the punching height (upper stop position) on the right front of the moving platen 1, and a right front punching height down button 72 for lowering the punching height on the right front.

At the lower left of the punching height distribution display 75, there is a left front punching height adjustment value display window 64 that shows the adjusted value of the second press motor 3b, and in the upper and lower parts thereof, it has a left front punching height up button 65 for raising the punching height on the left front of the moving platen 1, and a left front punching height down button 66 for lowering the punching height on the left front.

At the upper right of the punching height distribution display 75, there is a right back punching height adjustment value display window 67 that shows the adjusted value of the third press motor 3c, and in the upper and lower parts thereof, it has a right back punching height up button 68 for raising the punching height on the right back of the moving platen 1, and a right back punching height down button 69 for lowering the punching height on the right back.

At the upper left of the punching height distribution display 75, there is a left back punching height adjustment value display window 61 that shows the adjusted value of the fourth press motor 3d, and in the upper and lower parts thereof, it has a left back punching height up button 62 for raising the punching height on the left back of the moving platen 1, and a left back punching height down button 63 for lowering the punching height on the left back.

Furthermore, above the center of the punching height distribution display 75, there is an overall punching height up button 73 that raises the punching height of all four locations, and a total punching height down button 74 that lowers the punching height of all four locations.

In the present embodiment, the adjustment unit of the four corners of the punching height is “0.01 [mm]”, and the adjustment range is “0.00 to 2.50 [mm]”, but the adjustment range is not limited thereto.

In the present embodiment, in order to keep the counter plate 9 in a flat state, the diagonal corner is used as a fulcrum with respect to the corner for which the punching height is adjusted among the four corners, and the other two corners are changed to follow.

In the example shown in FIG. 12, the left back corner is adjusted to be raised by “0.09”. In this adjustment, the front right corner serves as a fulcrum, so the adjustment value does not change and remains at “0.00”. On the other hand, the other two corners (front left corner, back right corner) rise to follow the rise of the back left corner.

The punching height distribution display 75 shows an outline of the height distribution of the upper surface of the moving platen 1, divides the upper surface of the moving platen 1 into 16 regions, and displays the height of each area obtained by calculating based on the adjustment values of the four corners.

In FIG. 12, the punching height distribution display 75 shows the punching height distribution numerically, but the punching height distribution may be displayed in color.

When a setting to increase the punching pressure is input on the punching height adjustment screen shown in FIG. 12, the controller 30 changes the setting so as to increase the rotation amount at the upper reference rotation position of the corresponding press motor 3. In addition, when a setting for reducing the punching pressure is input, the controller 30 changes the setting so as to reduce the amount of rotation at the upper reference rotation position of the corresponding press motor 3. Then, during the punching process, the controller 30 controls to rotate in the forward direction up to the upper reference rotation position set for each press motor 3.

The die cutter 100 of the present embodiment has a configuration in which each of the four corners of the moving platen 1 that moves from the bottom to the top during the punching process is moved up and down by an independent press motor 3 and a lift transmission mechanism 4, and in addition thereto, each press motor 3 is configured to allow the rotation amount to be adjusted individually, so that it is possible to improve the uneven punching by adjusting the rising positions of the four corners according to the uneven punching.

Since the uneven punching is caused by the arrangement of the cutting blade 81 of the punching die 8 and the manufacturing error of the punching die 8, when the punching die 8 once removed is reattached to the die cutter 100, the same unevenness removing process as the previous mounting may be performed.

In the die cutter 100 of the present embodiment, the identification information for each punching die 8 and the control information are associated with each other and stored in the storage of the controller 30. The control information at this time includes information on the upper reference rotation positions of the four press motors 3 at the time of the previous mounting of the punching die 8. With this, the identification information is input when the punching die 8 is mounted, so that the control information associated with the identification information is called and the upper reference rotation positions of the four press motors 3 can be set to the setting at the time of the previous mounting, which makes it possible to reduce the work load during adjustment before mass production operation and shorten the setup time.

It is desirable that the punching die 8 includes an identification information display such as a barcode or a control number. Then, the identification information of the punching die 8 to be mounted can be input by reading the barcode with the barcode reader provided on the die cutter 100, or inputting the management number on the operation panel 101.

As a configuration for setting the upper reference rotation position according to the punching die 8, it may be configured that a readable storage element such as an RF tag or an IC tag is provided in the punching die 8, control information including information on the upper reference rotation position of the four press motors 3 at the time of the previous mounting is stored in the storage element of the punching die 8, and the upper reference rotation position is set based on the information of the storage element of the punching die 8 read at the time of mounting.

In the die cutter 100 of the present embodiment, when the new punching die 8 is mounted, the upper reference rotation position of the four press motors 3 can be set by the operation on the operation panel 101, and the uneven punching can be improved, so that it is possible to reduce the work of pasting the shim tape for removing unevenness. Furthermore, when the punching die 8 is mounted for the second time or more, the control information at the time of the previous mounting can be recalled and set by inputting the identification information, so that the adjustment before mass production operation can be semi-automated and simplified.

The control information associated with the identification information for each punching die 8 described above may include any one or more job setting information of the height of the cutting blade 81 of the punching die 8, the thickness of the sheet for the punching die 8, the usage history of the punching die 8, the punching die reference position and the like. Examples of the usage history include the date and time of use, the number of punches, and the like.

When there is a change in the control information stored in advance with the punching die 8 mounted, it is associated with the identification information and stored in the lookup table. Then, the next time the punching die 8 is mounted and the identification information is input, the associated control information is automatically called and the job setting is performed.

By associating the process that takes time for the adjustment of mounting and adjusting the punching die 8, the items in which the accuracy can be confirmed for the first time when waste paper is generated after actually processing, and the like as the control information with the identification information of the punching die 8, the work load on the user can be reduced, and the setup time can be shortened.

Since the upper stop position of the moving platen 1 is almost determined by the punching die 8, by acquiring the setting information of the upper reference rotation position of the four press motors 3 at the time of the previous installation as control information, the upper stop position of the moving platen 1 can be set automatically, which is advantageous in reducing the work load and setup time.

Input of the reference position of the punching die 8 is indispensable for the punching process. The adjustment time can be shortened by acquiring the information on the punching die reference position, which is the reference position of the punching die 8, as the control information and automatically setting it.

By acquiring the usage history of the punching die 8 as the control information, the date and time of use and the number of punches thereof can be recorded, and the management of the punching die 8 such as the replacement time of the cutting blade 81 becomes easy.

In addition, information on the consistency between the punching die 8 and the sheet material S such as paper may be included as the control information. In this case, an identifier such as a bar code is given to a part of the sheet material S to be punched out by the punching die 8. In addition, an identifier reading unit (CCD camera or the like) for reading the identifier of the sheet material S is arranged between the sheet feeder 200 and the die cutter 100. Then, before performing the punching process, it is confirmed whether or not the sheet material S and the punching die 8 are an appropriate combination based on the information acquired by the identifier reading unit and the identification information of the punching die 8. With this, it is possible to prevent any unnecessary punching process from being performed on the sheet material S that does not conform to the punching die 8, and it is possible to prevent the occurrence of waste paper and prevent any unnecessary punching process.

Leveling adjustment can be performed for the die cutter 100 of the present embodiment so that the upper surface of the moving platen 1 and the lower surface of the fixed platen 2 are brought closer to a parallel state when the moving platen 1 reaches the upper stop position.

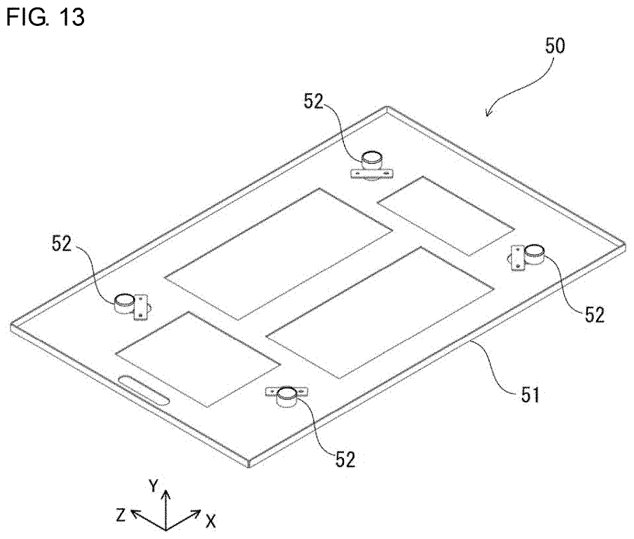

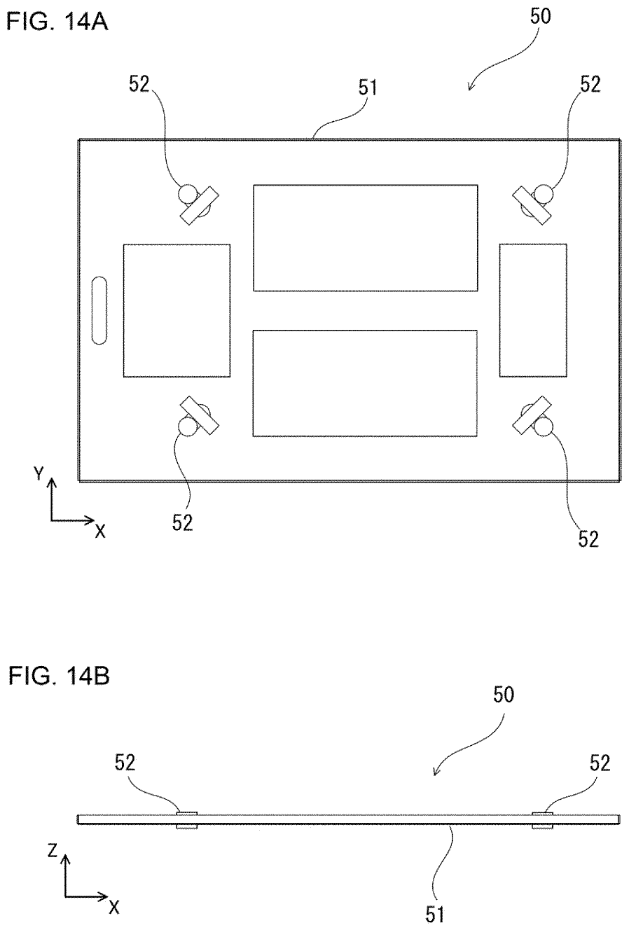

FIG. 13 is a perspective explanatory view of the leveling jig 50 used for leveling adjustment. FIGS. 14A and 14B show explanatory views of the leveling jig 50, FIG. 14A is a top view, and FIG. 14B is a front view.

The leveling jig 50 is used by being fixed to the fixed platen 2 instead of the punching die 8, and includes a jig main body plate portion 51 having the same outer shape as the punching die 8 and four spacers 52.

The spacer 52 is a highly rigid member that is not easily deformed, and is created with high precision so that the heights of the four spacers 52 (lengths in the Z direction in the figure) are uniform, and is fixed in a state of penetrating each of the four holes provided in the jig main body plate portion 51. The arrangement of the four spacers 52 is such that when the leveling jig 50 is fixed to the fixed platen 2, the four spacers 52 are positioned so as to face each other near the four corners of the upper surface of the rectangular moving platen 1.

When performing leveling adjustment, the operator fixes the leveling jig 50, instead of the punching die 8, to the fixed platen 2, mounts it to the die cutter 100, and inputs the operation, which is caused to perform leveling adjustment, on the operation panel 101. The controller 30 to which the leveling adjustment operation is input rotates the four press motors 3 in the forward direction at the same time from the state where the four columnar portions 10 are located at the bottom dead center. After the four lift transmission mechanisms 4 are rotated in the forward direction by a preset predetermined rotation amount (constant pulse) within the range where the moving platen 1 does not reach the leveling jig 50, the control of the four press motors 3 is switched to the torque limit set to low torque (control to stop the rotation of the press motors 3 when the set torque is reached). The low torque here is torque required to raise the moving platen 1, and is torque with which, when the moving platen 1 hits something, the moving platen 1 cannot be moved any more. The moving platen 1 is rotated, so that the moving platen 1 stops when it comes into contact with the spacer 52 of the leveling jig 50, with extremely low torque at least immediately before contact. Then, the stopped position is stored as a horizontal reference position.

In the leveling adjustment, as a target of the rotation positions where the four columnar portions 10 become the top dead centers, the respective press motors 3 of the corresponding four lift transmission mechanisms 4 are rotationally driven.

However, in the control of the torque limit of low torque, when the upper surface of the moving platen 1 comes into contact with the spacer 52 of the leveling jig 50 and hits the lower surface of the fixed platen 2 via the spacer 52, even if the columnar portion 10 has not reach the rotation position that is the top dead point, the rotation of the press motor 3 is stopped, resulting in a position deviation error. For example, when the drive pulse of the press motor 3, when the lift transmission mechanism 4 is driven so that the columnar portion 10 moves from the bottom dead center to the top dead center, is 1000 pulses, the controller 30 drives the press motor 3 with a target of 1000 pulses, but if the moving platen 1 hits the moving platen 1 during 995 pulse drive and the press motor 3 cannot be driven due to torque limitation, a position deviation error occurs.

Since the heights of the four spacers 52 match with high accuracy, the upper surface of the moving platen 1 and the lower surface of the fixed platen 2 are parallel in a state where the moving platen 1 abuts on the fixed platen 2 via the four spacers 52. At this time, since the rotation positions of the four press motors 3 are rotation positions where the upper surface of the moving platen 1 and the lower surface of the fixed platen 2 can be parallel to each other, the rotation positions are stored in the storage of the controller 30 as horizontal reference positions, respectively. By setting the upper reference rotation positions of the four press motors 3 based on the horizontal reference positions stored here, the upper surface of the moving platen 1 and the lower surface of the fixed platen 2, when the moving platen 1 reaches the upper stop position, can be brought closer to a parallel state.

After the rotation of the four press motors 3 is stopped due to a position deviation error, and the rotation position at that time is stored as the horizontal reference position, such a control may be repeated that the four press motors are rotated slightly in the reverse direction, and then the four press motors are rotated in the forward direction again by controlling the torque limit of low torque. Then, the information of the horizontal reference position where the rotation is stopped due to the position deviation error is stored for each of the four press motors 3 for a plurality of times, the average of the horizontal reference positions for the plurality of times stored for each press motor 3 is calculated to set the horizontal reference position, and thereby more appropriate horizontal reference position information can be obtained.

When the thickness of the punching die 8 including the cutting blade 81 is larger than the height of the spacer 52, the upper reference rotation position is set so that the upper stop position is lowered by the difference. In addition, when the thickness of the punching die 8 including the cutting blade 81 is smaller than the height of the spacer 52, the upper reference rotation position is set so that the upper stop position is higher by the difference. With this, when the punching die 8 is mounted and the punching process is performed, it is possible to prevent the pressure variation of the counter plate 9 with respect to the punching die 8 from becoming large. In any case, the value of the difference to be subtracted or added is the same for each of the four press motors 3.

In the conventional die cutter, leveling that corrects the parallelism between the moving platen and the fixed platen is not performed. For this reason, when the parallelism between the moving platen and the fixed platen deteriorates due to assembly error during manufacturing of the die cutter, component error, or continuous use, only the work of pasting the shim tape for removing unevenness is performed so as to correct the uneven punching due to the deterioration of parallelism, and the parallelism itself is not improved. With such a conventional die cutter, it is necessary to correct the deteriorated parallelism additionally with a shim tape, which increases the work load on the operator and may not sufficiently eliminate the uneven punching depending on the ability of the operator. Furthermore, when correcting the deteriorated parallelism additionally with shim tape, it is necessary to paste a large amount of shim tape at the same position each time, which increases the number of test feeds and increases the amount of waste paper.

With the die cutter 100 of the present embodiment, by the leveling adjustment before mounting the punching die 8, it is possible to prevent the occurrence of the uneven punching due to the deterioration of parallelism during the test feeding with the punching die 8 mounted, and to reduce the work load for correcting uneven punching by an operator. In addition, since the leveling adjustment is performed by the control of the controller 30, it is possible to eliminate the uneven punching caused by the deterioration of the parallelism regardless of the ability of the operator. Furthermore, it is possible to reduce waste paper.

As shown in FIG. 2, the die cutter 100 includes a first strain sensor 26a and a second strain sensor 26b on the upstream side and the downstream side in the transport direction of the front frame 5. In addition, as shown in FIGS. 3 and 4, a third strain sensor 26c and a fourth strain sensor 26d are provided on the upstream side and the downstream side in the transport direction of the back frame 6.

The four strain sensors 26 (26a, 26b, 26c, 26d) are elongation amount measuring units that measure the amount of vertical elongation of the front frame 5 and the back frame 6, which are holding members for holding the fixed platen 2 among the frames of the die cutter 100.

The measurement points are a plurality of points (two points in the present embodiment) separated from each other in the transport direction on each of the front frame 5 and the back frame 6, which are frames on both sides of the transport path of the sheet material S.

The four strain sensors 26 are fixed near the upper end of the front frame 5 or the back frame 6, and strain detection rods 27 (27a, 27b, 27c, 27d) are arranged below the strain sensors 26, respectively. The lower ends of the four strain detection rods 27 are fixed to the detection rod fixing portions 28 (28a, 28b, 28c, 28d) near the lower ends of the front frame 5 or the back frame 6. Since only the lower end of the strain detection rod 27 is fixed to the front frame 5 or the back frame 6, the position of the upper end thereof is not affected by the deformation of the front frame 5 or the back frame 6. On the other hand, since the strain sensor 26 is arranged at the upper end of the front frame 5 or the back frame 6, when the front frame 5 or the back frame 6 is extended, the strain sensor 26 moves upward and the distance to the upper surface of the facing strain detection rod 27 increases, and when the elongation is eliminated, the distance from the strain sensor 26 to the upper surface of the strain detection rod 27 also returns to the original. Therefore, the strain sensor 26 can detect the amount of elongation of the front frame 5 or the back frame 6 at the arranged position by measuring the change in the distance to the upper surface of the strain detecting rod 27 arranged so as to face each other.

The four strain sensors 26 detect the amount of elongation of the front frame 5 and the back frame 6 at the installed positions as an electric signal. The controller 30 can control the drive of each of the four press motors 3 based on the measurement results of the strain sensors 26.

At the moment when the sheet material S is punched out with the die cutter 100, a large load is applied in the vertical direction, and the frame is extended. When the frame is extended, the punching pressure when the moving platen 1 is moved to the upper stop position is reduced, which may cause uneven punching. Since the elongation of the frame changes depending on the job (combination of the punching die 8 and the sheet material S, etc.) and adjustment, during the adjustment process, the rotation amount corresponding to the upper reference rotation position of each press motor 3 is corrected according to the measurement results of each strain sensor 26. The larger the elongation measured by the strain sensor 26, the closer the correction of the upper reference rotation position of the corresponding press motor 3 brought to the rotation position where the columnar portion 10 becomes the top dead center is performed. With this, at the position where the elongation of the frame becomes large at the time of punching among the four corners, the upper stop position of the moving platen 1 at the time of punching can be raised to correct the decrease in punching pressure due to the elongation of the frame in advance. For this reason, it is possible to reduce the work load for the operator to see the product portion in the test feed and correct the uneven punching, and to shorten the adjustment time.

The strain sensor 26, which is an elongation amount measuring unit, detects fluctuations in the distance between the strain sensor 26 fixed near the upper end of the frame and the strain detecting rod 27 fixed near the lower end of the frame. As a configuration for detecting the fluctuation of the distance, it may be configured that a rotation lever that is rotatable with respect to the strain sensor 26 main body and contacts the upper surface of the strain detection rod 27 is provided, and the angle of the rotation lever is detected by the detector of the strain sensor 26, and the fluctuation of the distance between the strain sensor 26 and the strain detection rod 27 can be detected based on the detection angle. In addition, as another configuration of the elongation amount measuring unit, it may be configured to calculate the distance from a reflective optical distance sensor fixed near one of the upper end and the lower end of the frame to a reflector fixed near the other of the upper end and lower end of the frame Furthermore, the elongation amount measuring unit for measuring the elongation of the frame is not limited to the one using a distance sensor such as the strain sensor 26, and may be a unit for measuring the elongation of the frame by pasting a strain gauge to the frame.

The four press motors 3 may be torque-limited during the punching process in order to prevent damage to each member included in the die cutter 100 due to an overload when the four press motors 3 are driven.

In this case, it is desirable for the controller 30 to perform control to change the upper limit value of the torque generated by the corresponding press motor 3 according to the rotation position of each of the four eccentric shafts 44 (rotation angle of the eccentric shaft 44 when the columnar portion 10 is the bottom dead center as θ=0[°]).

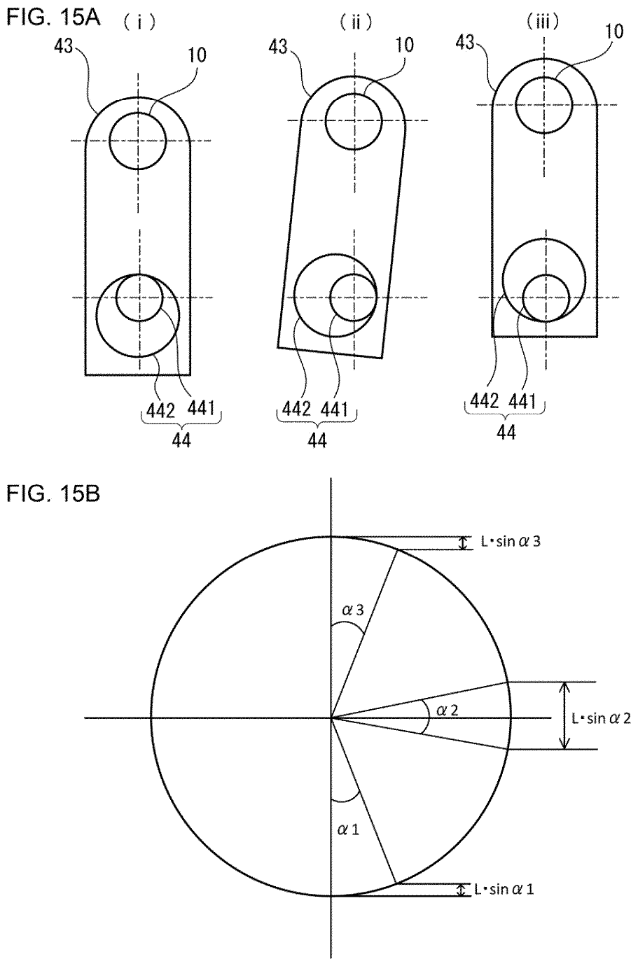

FIGS. 15A and 15B are explanatory diagrams showing a difference in the amount of displacement of the eccentric shaft portion 442 due to a difference in the rotation position of the eccentric shaft 44.

FIG. 15A is an explanatory diagram of the movements of the lift transmission rod 43 and the columnar portion 10 when the eccentric shaft 44 is rotated, and FIG. 15B is an explanatory diagram showing the difference of the displacement amount of the eccentric shaft portion 442 with respect to the same rotation amount (α1=α2=α3) in a state in which the rotation positions of the eccentric shaft 44 are different. “L” in FIG. 15B is the distance between the center line of the rotation shaft portion 441 of the eccentric shaft 44 and the center line of the eccentric shaft portion 442.

“α1” in FIG. 15B indicates a state in which the eccentric shaft 44 is rotated by “a” in the rotation angle from the state of “0[°]” as shown in (i) of FIG. 15A, and the displacement amount thereof is “L·sin α1”. “α2” indicates a state in which the eccentric shaft 44 is rotated by “a” in the rotation angle near “90[°]” as shown in (ii) of FIG. 15A, and the displacement amount thereof is “L·sin α2”. “α3” indicates a state in which the eccentric shaft 44 is rotated by “α” in the rotation angle toward a state in which the rotation angle of the eccentric shaft 44 becomes “180[°]” as shown in (iii) of FIG. 15A, and the displacement amount thereof is “L·sin α3”.

As shown in FIG. 15B, with the rotation angle near “0[°]” or “180[°]”, the displacement amount “L·sin α” with respect to the rotation amount “α” is sufficiently small compared to that with the rotation angle near “90[°]”. Thus, even if the torque generated by the press motor 3 is the same, the force for raising the columnar portion 10 is sufficiently larger with the rotation angle near “0[°]” or “180[°]” than that with the rotation angle near “90[°]”.

Thus, when the upper limit value of the generated torque is constant, if the upper limit value of the generated torque is set to a high value so that the moving platen 1 can be smoothly raised with the rotation angle near “90[°]”, even if a large load is applied to the members included in the die cutter 100 such as the columnar portion 10 with the rotation angle near “0[°]” or “180[°]”, the generated torque of the press motor 3 does not reach the upper limit value, and the press motor 3 may continue to be driven to damage the members included in the die cutter 100. In particular, when punching when the rotation angle reaches the vicinity of “180[°]”, if the generated torque is difficult to reach the upper limit, even if the resistance during punching increases due to a paper jam or catching of some article, etc., the generated torque does not reach the upper limit value, and the press motor 3 is driven until the set upper stop position is reached, which may damage the members included in the die cutter 100.

On the other hand, when the rotation angle is near “0[°]” or “180[°]” and the upper limit of the generated torque is set to a low value so as to prevent damage to the member, there is a risk that the force required to smoothly raise the moving platen 1 cannot be obtained with the rotation angle near “90[°]”.

On the other hand, the upper limit value of the torque generated by the press motor 3 is changed according to the rotation angle of the eccentric shaft 44 and the like. Specifically, when the rotation angle is near “90[°]”, the upper limit of the torque generated by the press motor 3 is set to a high value, and the setting of the upper limit value of the generated torque of the press motor 3 is changed so that the value becomes smaller in a gradual or stepwise manner as the rotation angle is closer to “180[°]”.

Then, during the punching operation, if the torque generated by the press motor 3 reaches the upper limit value before reaching the upper stop position, the drive of the press motor 3 is stopped and an error is displayed on the display such as the operation panel 101.

In this way, the moving platen 1 can be smoothly raised by setting the upper limit value of the generated torque to a high value until it approaches the upper stop position, and after approaching the upper stop position, the load on the device can be reduced and damage to the members included in the die cutter 100 such as the punching die 8 and the lift transmission mechanism 4 can be prevented by changing the upper limit value of the generated torque to a lower value.

As a configuration for changing the upper limit value of the generated torque, control may be performed to reduce the upper limit value of the generated torque of the press motor 3 when the moving platen 1 approaches the upper stop position. The torque is most required at the start of ascending of the moving platen 1, and the required torque decreases as it approaches the upper stop position.

Since the moving platen 1 used in the die cutter 100 of the present embodiment is very heavy (about 280 [kg]), large torque is required to start and accelerate it. Thus, when starting to move the moving platen 1 at the lower stop position, the torque generated by the press motor 3 is set not to have an upper limit so that the maximum torque of the press motor 3 can be applied. Then, when approaching the upper stop position for punching, the upper limit value of the generated torque of the press motor 3 is limited so that the vertical force acting on the lift transmission rod 43, the columnar portion 10 and the moving platen 1 via the eccentric shaft 44 does not exceed a certain value.

The die cutter 100 sandwiches and transports the sheet material S between a transfer belt pair (14, 15) arranged on the back side in the width direction, which is outside the facing range below the punching die 8.

In addition, the stop timing of the belt drive motor 13 is determined based on the detection result of the rear end detection sensor 25 arranged near the upstream side end of the transport belt pair (14, 15).

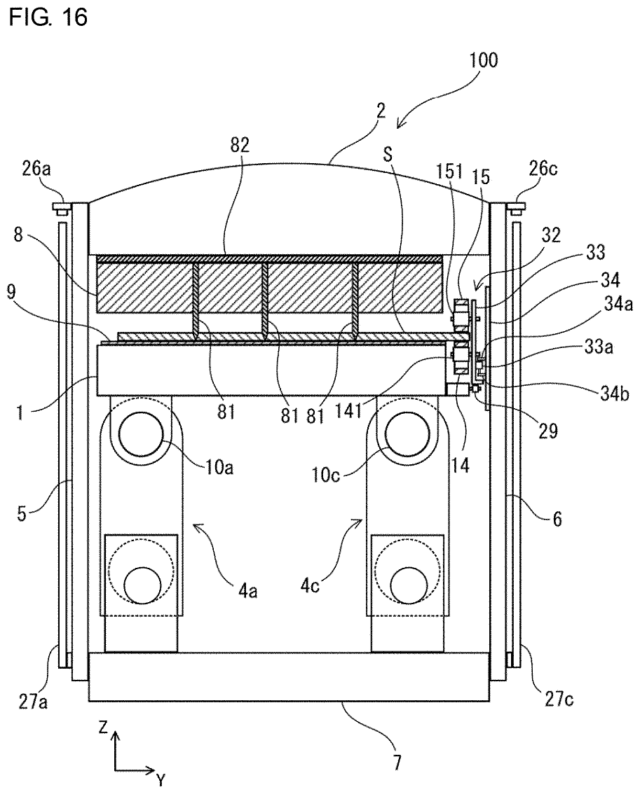

As shown in FIG. 16, the die cutter 100 includes a belt support mechanism 32 that supports a pair of transport belts (14, 15). The belt support mechanism 32 includes a fixed plate 34 fixed to the back frame 6 and a movable plate 33 that can move in the vertical direction with respect to the fixed plate 34.

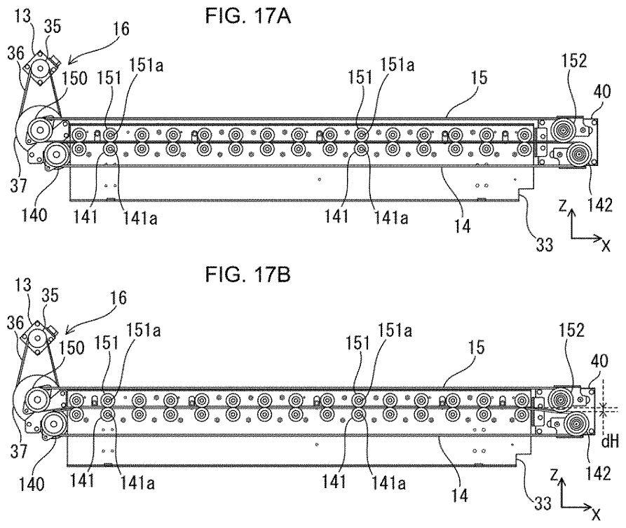

FIGS. 17A and 17B are front views of the transport belt pair, FIG. 17A is an explanatory view before punching, and FIG. 17B is an explanatory view at the time of punching.

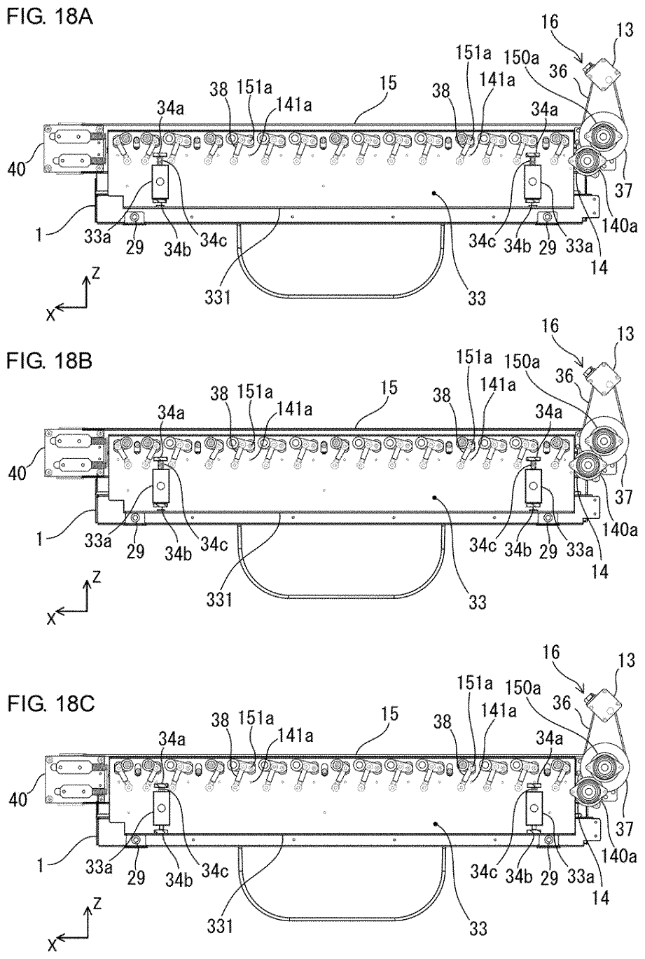

FIGS. 18A to 18C are rear views of the transport belt pair and the moving platen, FIG. 18A is an explanatory view before punching, FIG. 18B is an explanatory view during punching, and FIG. 18C is an explanatory view at the time of punching.

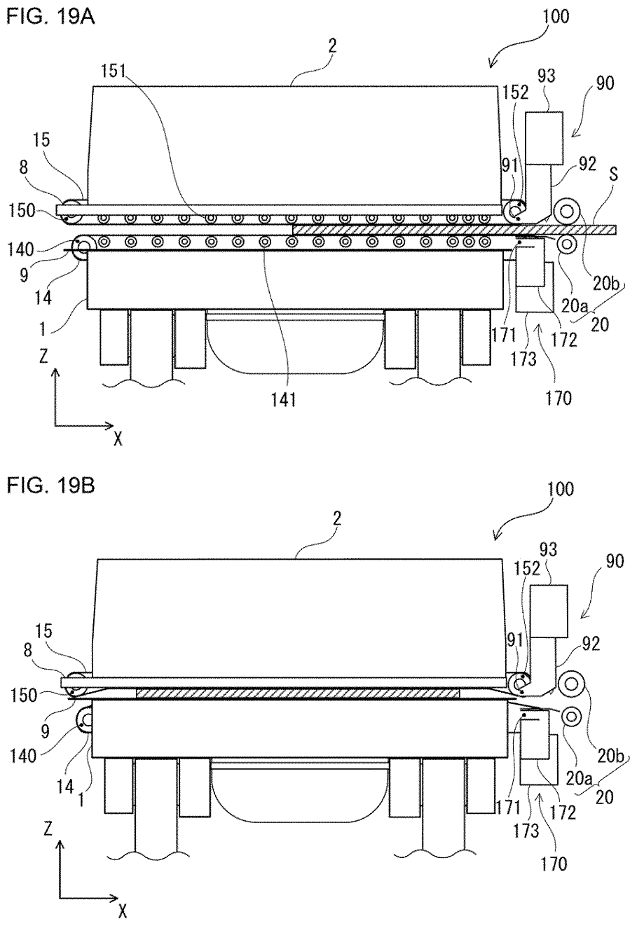

FIGS. 19A and 19B are schematic views of the front surface of the die cutter 100, FIG. 19A is an explanatory view during transporting the sheet material S toward the punching region, and FIG. 19B is an explanatory view with the moving platen 1 raised after stopping the sheet material S in a punching region.

The lower transport belt 14 is stretched on the lower drive roller 140, a plurality of stretching rollers 141 and the lower tension roller 142, and the upper transport belt 15 is stretched on the upper drive roller 150, the plurality of upper stretching rollers 151 and the upper tension roller 152.

When the belt drive motor 13 is driven, rotational drive is transmitted via the drive output gear 35, the drive output belt 36, and the belt drive gear 37, the upper drive roller 150 and the drive transmission gear 150a rotate, and the upper transport belt 15 rotates. When the drive transmission gear 150a rotates, the lower belt drive input gear 140a rotates, the lower drive roller 140 coaxial with this rotates, and the lower transport belt 14 rotates.

The lower tension roller 142 and the upper tension roller 152 apply tension to the lower transport belt 14 and the upper transport belt 15.

The plurality of lower stretching rollers 141 and the plurality of upper stretching rollers 151 forming a portion sandwiching the sheet material S between the upper stretching surface of the lower transport belt 14 and the lower stretching surface of the upper transport belt 15 are supported by a movable plate 33, which is a roller holding member. The moving platen 1 includes a protrusion 29 protruding to the back side in the width direction.

When the moving platen 1 rises, the protrusion 29 comes into contact with the lower surface of the lower bent portion of the movable plate 33 as shown in FIG. 18B. Furthermore, as the moving platen 1 rises, the protrusion 29 pushes up the movable plate 33, and the lower stretching roller 141 and the upper stretching roller 151 held by the movable plate 33 rise. Then, the portion sandwiching the sheet material S between the upper stretching surface of the lower transport belt 14 and the lower stretching surface of the upper transport belt 15 rises together with the moving platen 1 (by the distance “dH” shown with the broken line in FIG. 17B) to be in the states shown in FIGS. 17B, 18C and 19B.

During the punching process, the sheet material S is pushed up by the moving platen 1 due to the ascent of the moving platen 1, and the tip of the cutting blade 81 of the punching die 8 on the fixed platen 2 side and the surface of the moving platen 1 (counter plate 9) sandwich the sheet material S. Then, when the moving platen 1 is further raised, the sheet material S is punched into the shape of the cutting blade 81 of the punching die 8. By sandwiching the sheet material S between the moving platen 1 and the cutting blade 81, the relative position of the sandwiched portion with respect to the moving platen 1 is fixed. After that, when the moving platen 1 is further raised, the portion of the sheet material S sandwiched between the moving platen 1 and the cutting blade 81 is raised. At this time, when the vertical distance between the portion of the sheet material S sandwiched between the moving platen 1 and the cutting blade 81 and the portion held by the transport belt pair (14, 15) is separated, a force pulling the sheet material S acts, which may damage the sheet material S.

In the present embodiment, the upper stretching surface of the lower transport belt 14 and the lower stretching surface of the upper transport belt 15 rise in conjunction with the rise of the moving platen 1. Thus, the position where the sheet material S is sandwiched between the moving platen 1 and the cutting blade 81 (fixed platen 2) and the position where the transport belt pair (14, 15) holds the sheet material S can be prevented from being separating in the vertical direction. With this, it is possible to prevent a pulling force from acting on the sheet material S during the punching process, and it is possible to prevent damage to the sheet material S.

In addition, it is possible to prevent the sheet material S pushed up by the moving platen 1 in a state before coming into contact with the cutting blade 81 from being pulled by the holding unit having a fixed position to be deviated from the range of the sheet material S facing the moving platen 1, and it is possible to prevent the sheet material S from being displaced at the punched portion, so that the punching process can be performed with high accuracy.

As shown in FIGS. 18A to 18C, the lower stretching roller shaft 141a, which is the rotation shaft of the lower stretching roller 141, has a fixed position with respect to the movable plate 33, and the upper stretching roller shaft 151a, which is the rotation shaft of the upper stretching roller 151, is movable in the vertical direction with respect to the movable plate 33. By urging the upper stretching roller shaft 151a toward the lower stretching roller shaft 141a by the stretching roller urging spring 38, the upper stretching roller 151 sandwiches the upper transport belt 15 and the lower transport belt 14 and abuts on the lower stretching roller 141.

The fixed plate 34 includes an upper protruding plate 34a and a lower protruding plate 34b protruding toward the front side, and includes a stretching belt slide shaft 34d connecting the upper protruding plate 34a and the lower protruding plate 34b.

The movable plate 33 protrudes to the back side and includes a slide member 33a located between the upper protruding plate 34a and the lower protruding plate 34b. The stretching belt slide shaft 34d penetrates the slide member 33a, the slide member 33a moves up and down along the stretching belt slide shaft 34d, and thereby the movable plate 33 moves in the vertical direction. A movable plate positioning spring 34c is provided between the slide member 33a and the upper protruding plate 34a to press the slide member 33a downward.

Before the moving platen 1 rises, the slide member 33a pressed by the movable plate positioning spring 34c abuts on the lower protruding plate 34b, and thereby the position of the movable plate 33 having the slide member 33a with respect to the fixed plate 34 is determined and the vertical positions of the upper stretching roller 151 and the lower stretching roller 141 held by the movable plate 33 are determined. When the moving platen 1 rises and the protrusion 29 pushes up the movable plate 33, the slide member 33a rises and the movable plate positioning spring 34c is in a compressed state, as shown in FIG. 18C. The position of the movable plate 33 is determined by the urging force of the movable plate positioning spring 34c and the abutment with the protrusion 29.

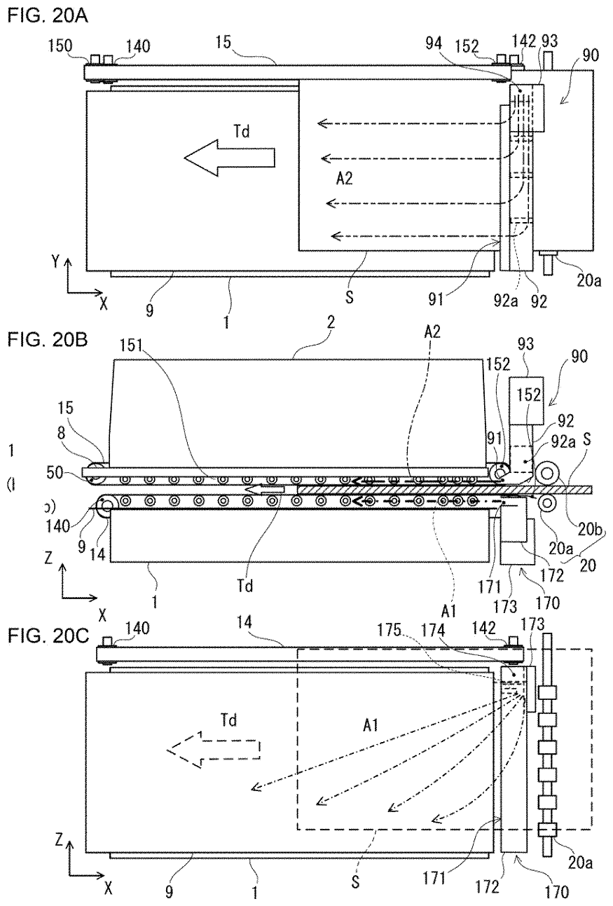

FIGS. 20A to 20C are explanatory views of the die cutter 100 during transporting the sheet material, and FIG. 20A is a schematic view in which the upper airflow A2 is added to the plan view above the region through which the sheet material S passes. FIG. 20B is a schematic view in which the upper airflow A2 and the lower airflow A1 are added to the front view of the die cutter 100. FIG. 20C is a schematic view in which the lower airflow A1 is added to the plan view below the region through which the sheet material S passes.

As shown in FIGS. 20A to 20C, the die cutter 100 includes a lower airflow generator 170 and an upper airflow generator 90 that generate an air flow in a region through which the sheet material S held and transported by the transfer belt pair (14, 15) passes.

In FIGS. 20A to 20C, the lower airflow A1 generated by the lower airflow generator 170 is indicated by the alternate long and short dot line, and the upper airflow A2 generated by the upper airflow generator 90 is indicated by the alternate long and two short dashes line. In addition, the transport direction of the sheet material S is indicated by an arrow “Td”, and the portion where the sheet material S is located above in FIG. 20C is indicated by a broken line.

In the lower airflow generator 170, the airflow generated by the lower blower 173 passes through the lower airflow rising guide pipe 174 and flows into the back side end of the lower airflow horizontal guide pipe 172 in the width direction to pass through the gap formed by the lower airflow pipe wall portion 175 to flow toward the front side in the width direction. The airflow that reaches the front side of the lower airflow pipe wall portion 175 is discharged as the lower airflow A1 from the lower airflow port 171.

By flowing in through the gap formed by the lower airflow pipe wall portion 175, the airflow is directed from the back side to the front side in the width direction. In addition, the airflow flows out from the lower airflow port 171 opened on the downstream side in the transport direction of the lower airflow horizontal guide pipe 172, and thereby the airflow is directed in the transport direction. Therefore, as shown in FIG. 20C, the lower airflow A1 is an airflow inclined so as to go from the back side to the front side in the width direction with respect to the transport direction “Td”.

The sheet material S, which is transported while holding only the end on the back side in the width direction, may hang down on the front side in the width direction and come into contact with the counter plate 9 fixed to the upper surface of the moving platen 1 and be damaged. In the die cutter 100, the lower airflow A1 is discharged from the lower airflow port 171 to the lower surface of the sheet material S in the region through which the sheet material S held and transported by the transport belt pair (14, 15) passes. An airflow that pushes up the lower surface of the sheet material S or an airflow layer below the sheet material S can be formed. Therefore, it is possible to suppress the sheet material S from coming into contact with the lower member, and it is possible to suppress damage to the sheet material S.

In addition, the airflow from the lower airflow port 171 toward the punching region can suppress the head wind to the sheet material S to be transported, and can suppress the curling of the sheet material S. Further, it is possible to suppress the front side of the sheet material S from fluttering due to the air flow from the back side to the front side. Therefore, it is possible to suppress the sheet material S from coming into contact with the members located above and below the sheet material S due to curling or fluttering.

As a configuration for blowing the airflow on the lower surface of the sheet material S during transportation, the airflow may be blown from below the transport belt pair (14, 15) holding the sheet material S on the back side in the width direction. That is, such a configuration that an airflow pushing up the lower surface of the sheet material S or an airflow layer below the sheet material S is formed is only needed.

In the upper airflow generator 90, the airflow generated by the upper blower 93 passes through the upper airflow down guide pipe 94 and flows into the upper airflow horizontal guide pipe 92. A plurality of rectifiers 92a are provided in the upper airflow horizontal guide pipe 92, and above the rectifiers 92a in the upper airflow horizontal guide pipe 92, there is a flow path through which the airflow can pass. The gas flowing into the upper airflow horizontal guide pipe 92 passes between the rectifiers 92a while passing through the flow path above the rectifiers 92a. At the time of this passing, it is rectified into an airflow along the transport direction “Td” and discharged as an upper airflow A2 from the upper airflow port 91.

In the die cutter 100, the upper airflow A2 is discharged from the upper airflow port 91 to the upper surface side of the sheet material S held and transported by the transfer belt pair (14, 15). With this, an airflow layer can be formed above the sheet material S, and it is possible to suppress the sheet material S from coming into contact with the lower surface of the member located above.

In addition, the orientation of the sheet material S can be stabilized by lifting the front side of the sheet material S with the airflow from the lower airflow generator 170 and the upper airflow generator 90 and bringing it closer to the horizontal.

In the die cutter 100 of the present embodiment, in the punching process during mass production processing, the moving platen 1 is configured to reciprocate between the lower stop position and the upper stop position, and is controlled so as to move without stopping in the process of descending from the upper stop position to the lower stop position. On the other hand, it may be possible to select such a second punching control that the reverse drive of the four press motors 3 is stopped and the drive of the belt drive motor 13 is restarted so that the moving platen 1 is stopped at the timing when the sheet material S punched by the punching die 8 is lowered to the transport height. In this second punching control, after the rear end of the punched sheet material S passes above the moving platen 1, the reverse drive of the four press motors 3 is restarted, and the moving platen 1 is lowered to the lower stop position and stopped to prepare for the next punching operation.

In the normal punching process of the die cutter 100, the product portion and the nonproduct portion of the sheet material S after the punching process are not completely separated. This is because when the portion held by the holder such as the transport belt pair (14, 15) is a nonproduct portion, the product portion may fall in the device, and when the portion to be the product portion is held, the nonproduct portion may fall in the device. For this reason, the cutting blade 81 of the punching die 8 has a shape that leaves a narrow connecting line called “nick” that connects the product portion and the nonproduct portion. Then, the nick is cut by pushing down the nonproduct portion with the separator to obtain the product portion. On the other hand, by performing the second punching control, even if the product portion and the nonproduct portion are completely separated by the punching process, the upper surface of the moving platen 1 (the upper surface of the counter plate 9) supports the lower surface of the sheet material S, so that it is possible to prevent a portion, which is not held by the holder, of the nonproduct portion and the product portion from falling down into the device and to discharge the product portion and the nonproduct portion out of the die cutter 100. With this, it is not necessary to cut the nick of the sheet material S after discharge, it is possible to prevent the nick mark from remaining on the product portion, and it is possible to improve the quality of the product portion.

Examples of the sheet material S, which is a plate-shaped workpiece, include paper media such as plain paper, cardboard, label paper, thick paper, and coated paper. In addition to paper media, plate-shaped workpieces to be processed by the punching device according to the present invention include OHP sheets, films, fabrics, resin sheets, metal sheets, electronic circuit board materials to which metal foils, plating treatments, and the like are applied, special films, plastic films, prepregs, sheets for electronic circuit boards, and the like, which may be a bundle of a plurality of sheets or a single sheet.

Although the configuration in which the moving platen is arranged below and the fixed platen is arranged above has been described, the moving platen may be arranged above and the fixed platen may be arranged below. Furthermore, it may be configured that both of the two platens facing each other in the vertical direction may be movable moving platens that can be moved up and down, and are brought into contact with each other by a plurality of (four) lift drive sources.

In the configuration in which the moving platen is arranged below and the fixed platen is arranged above as in the present embodiment, the four press motors 3 having a certain weight and the four lift transmission mechanisms 4 can be arranged in a low position in the device, and the center of gravity of the device of the die cutter 100 can be lowered.

What has been described above is an example, and each of the following aspects produces a unique effect.

### Aspect 1

A punching device such as a die cutter 100, includes: a moving platen such as a moving platen 1 and a facing platen such as a fixed platen 2 structured to be vertically arranged to face each other; a moving mechanism structured to cause the moving platen to vertically move toward the facing platen; and a control unit such as a controller 30 structured to control the moving mechanism, wherein the punching device such as the die cutter 100 punches a workpiece such as a sheet material S into a predetermined shape with a punching die such as a punching die 8 attached to at least one of the moving platen and the facing platen by bringing the moving platen closer to the facing platen using the moving mechanism, and the moving mechanism includes: a plurality of (such as four) pressurizing mechanisms such as lift transmission mechanisms 4 structured to pressurize the moving platen toward the facing platen with a plurality of (such as four) pressurizers such as columnar portions 10 having different positions in a horizontal direction from one another, respectively; and a plurality of (such as four) drive sources such as press motors 3 structured to drive the plurality of pressurizing mechanisms, respectively.

According to this, since the control unit independently controls a plurality of drive sources, the amount of pressurization in the plurality of pressurizers can be adjusted independently, and it is possible to adjust the punching pressure to suppress uneven punching pressure without providing a drive source dedicated to the punching pressure adjustment.

### Aspect 2

In the punching device of aspect 1, the pressurizing mechanisms are eccentric rotating body drive transmission mechanisms that convert rotational movement of the drive sources into vertical movement of the moving platen by an eccentric rotating body such as an eccentric shaft 44.

When a ball screw is also used as a pressurizing mechanism for pressurizing and moving the moving platen, the amount of movement of the moving platen is constant with respect to the amount of rotation output by the drive source.

On the other hand, in the eccentric rotating body drive transmission mechanism, it is possible to finely adjust the pressure at the time of punching while increasing the moving speed of the moving platen in the moving range that does not contribute to punching. This is due to the following reasons.

That is, when the position of the pressurizer is near the middle between the bottom dead center and the top dead center (for example, in the state of FIG. 11B), the vertical displacement with respect to the rotation amount becomes large, so that by setting this range to be the moving range of the moving platen that does not contribute to punching, the moving speed of the moving platen in the moving range that does not contribute to punching can be increased. On the other hand, when the position of the pressurizer is near the top dead center or the bottom dead center, the displacement in the vertical direction with respect to the rotation amount becomes small, so that by setting the stop position of the pressurizer at the time of pressurization such as the upper stop position to the top dead center or the bottom dead center, the displacement of the pressurizer in the vertical direction with respect to the rotation amount can be reduced, the stop position of the pressurizer during pressurization can be finely set, and the pressure during punching can be finely adjusted.

### Aspect 3

In the punching device of aspect 2, in pressurizing operation such as rising operation in which the pressurizing mechanisms pressurize the moving platen toward the facing platen, the pressurizers are displaced to a stop position such as an upper stop position so as not to reach a dead center such as an upper dead center of the eccentric rotating body drive transmission mechanisms.

In the present aspect, the eccentric rotating body does not make one rotation, and the pressurizer is displaced in the range sandwiched between the top dead center and the bottom dead center. Then, when pressurizing by raising the moving platen toward the facing platen arranged above as in the above-described embodiment, the pressurizer is displaced to the upper stop position set at a position lower than the top dead center. In addition, unlike the above-described embodiment, when pressurizing by lowering the moving platen toward the facing platen arranged below, the pressurizer is displaced to the lower stop position set at a position higher than the bottom dead center. By setting the stop position of the pressurizer at the time of pressurization to a position so as not to reach the dead center, the stop position of the pressurizer at the time of pressurization can be adjusted in the vertical direction, and by adjusting the stop position of the pressurizer during pressurization for each of the plurality of pressurizing mechanisms, the punching pressure can be adjusted so as to eliminate uneven punching.

### Aspect 4

In the punching device of any of aspect 2 or 3, the control unit limits generated torque when the drive sources are driven, and an upper limit value of the generated torque is changed depending on a rotation position of the eccentric rotating body such as a rotation angle of the eccentric shaft 44 when θ=0[°] when the columnar portion 10 is at the bottom dead center.

According to this, while maintaining the torque required to move the moving platen when the moving amount of the moving platen with respect to the rotation angle of the eccentric rotating body is large, it is possible to prevent damage to the members included in the punching device when the moving amount of the moving platen with respect to the rotation angle of the eccentric rotating body is small.

### Aspect 5

In the punching device of any one of aspects 1 to 4, each of the pressurizers is arranged to be located at each corner of a rectangle to be included within a region of the moving platen.

In JP 2011-136394 A, only the punching pressure in the front-rear direction can be adjusted with respect to the transport direction of the sheet material, and the punching pressure in the left-right direction cannot be adjusted with respect to the transport direction of the sheet material. As in the present aspect, the pressurizers are arranged at four locations that are the vertices of the rectangle included in the range of the moving platen, the control unit independently controls the drive source of the pressurizing mechanism of each pressurizer, and thereby it is possible to adjust the punching pressure not only in the front-rear direction but also in the left-right direction with respect to the transport direction of the sheet material, and it is possible to more appropriately eliminate the uneven punching.

### Aspect 6

In the punching device of any one of aspects 1 to 5, the punching device includes a plurality of deformation amount measuring units such as the strain sensor 26, which measure deformation amounts of members (the front frame 5 and the back frame 6, etc.) to be deformed during pressurizing by the pressurizing mechanisms, in positions where horizontal positions are different from one another, and the control unit controls driving of the drive sources based on measurement results of the deformation amount measuring units.

According to this, it is possible to correct the decrease in punching pressure due to the deformation of the member that is deformed during pressurization by the control unit, and it is possible to reduce the work load of adjusting the punching pressure. In the above-described embodiment, the case where the members, on which the deformation amount measuring unit measures the deformation amount, are the front frame 5 and the back frame 6 has been described, but the member for measuring the deformation amount is not limited thereto. For example, the contraction amount of the shaft holder 42 of each of the four lift transmission mechanisms 4 during pressurization may be measured to control the drive amount of the press motor 3 based on this contraction amount. Furthermore, both the contraction amount of the shaft holder 42 during pressurization and the elongation amount of the front frame 5 and the back frame 6 may be measured to control the drive amount of the press motors 3 based on the measurement results. A facing platen holding member that holds the facing platen like the front frame 5 and the back frame 6, and a moving platen holding member that holds the moving platen like a member included in the lift transmission mechanism 4 such as the shaft holder 42 are members that can be deformed by the action of stress during pressurization. In addition, not limited to these members, if the member is deformed during pressurization, the amount of deformation is measured, the drive source is controlled based on the measurement result, and thereby the decrease in the punching pressure caused by the deformation during pressurization can be corrected.

### Aspect 7

In the punching device of aspect 6, the deformation amount measuring unit is an elongation amount measuring unit, such as the strain sensor 26, for measuring an elongation amount in a vertical direction of a holding member, such as a front frame 5 and a back frame 6, that holds the facing platen.

According to this, it is possible to correct the decrease in punching pressure due to the elongation of the holding member during pressurization.

### Aspect 8

In the punching device of any one of aspects 1 to 7, the punching device includes a transporting unit, such as a lower transport belt 14 and an upper transport belt 15, structured to load and unload the workpiece between the moving platen and the facing platen.

According to this, in the punching device that automates the loading and unloading of the workpiece into the punching device, it is possible to make adjustments to suppress uneven punching pressure by the drive control of a plurality of drive sources that move the moving platen up and down without providing a drive source dedicated to punching pressure adjustment.

### Aspect 9

In the punching device of any one of aspects 1 to 8, the facing platen is an upwardly fixed platen structured to be fixed to a housing of the device above the moving platen.

According to this, by arranging the moving platen downward, the pressurizing mechanism and the drive source included in the moving mechanism can be arranged at a low position in the device, and the center of gravity of the device can be lowered, so that stable installation of the punching device is possible.

### Aspect 10

In the punching device of any one of aspects 1 to 9, a setting of a punching process such as a setting of the upper reference rotation positions of four press motors 3 is changed based on identification information of the punching die attached and control information (information of the upper reference rotation position of the four press motors 3 at the time of the previous mounting of the punching die 8) associated with the identification information.

According to this, it is possible to reduce the work load at the time of adjustment before mass production operation and shorten the setup time.

### Aspect 11

A punching device (100), includes: a moving platen (1) and a facing platen (2) structured to be arranged to face each other; moving mechanisms (3, 4) structured to cause the moving platen to move toward the facing platen; a punching area transporting unit (14,15) structured to transport a workpiece (S) to a punching area sandwiched between the moving platen and the facing platen; and a holding unit (14,15) structured to hold the workpiece located in the punched region, the punching device (100) including a holding unit moving mechanism (29, 33) structured to move the holding unit to a side (upward) of the facing platen according to the movement of the moving platen toward the facing platen.

According to this, the change in the position of the moving platen with respect to the holding unit can be suppressed.

The configuration for moving the holding unit according to the movement of the moving platen is not limited to the configuration in which the holding unit is interlocked by a common drive source, and it may be configured that the holding unit is moved according to the movement of the moving platen to the side of the facing platen by a separately provided drive source. In addition, it may be configured that the moving platen is located above the facing platen, and the holding unit is lowered according to the lowering of the moving platen during the punching process. Furthermore, as a mechanism that functions as a punching region transporting unit and a holding unit, it is applied to a mechanism in which a plurality of grippers are arranged on an endless chain as described in JP 2011-136394 A, and it may be configured to move the gripper according to the movement of the moving platen toward the facing platen during the punching process.

### Aspect 12

In the punching device of aspect 11, the holding unit moving mechanism has a pressing portion (29) that moves together with the moving platen and a pressed portion (33) that moves together with the holding unit, and when the moving platen moves toward the facing platen, the pressing portion presses the pressed portion and the holding unit moves to the facing platen side.

According to this, it is possible to realize a configuration in which the holding unit moves to the side of the facing platen in conjunction with the moving platen.

### Aspect 13

In the punching device of aspect 12, the pressing portion is not in contact with the pressed portion when the moving platen starts moving toward the facing platen, and the moving platen comes into contact with the pressed portion and presses it in the middle of moving toward the facing platen.

### Aspect 14

In the punching device of any one of aspects 11 to 13, the punching region transporting unit is a belt transporting device that sandwiches the workpiece between two belt members (14, 15) and transports it, the two belt members are located outside the moving platen in the width direction, and have a function as a holding unit by sandwiching and holding a portion of the workpiece located in the punching region that protrudes from the punching region, and the holding unit moving mechanism is a mechanism in which the portion of the two belt members sandwiching the workpiece moves toward the facing platen side according to the movement of the moving platen toward the facing platen.

According to this, it is configured to sandwich and transport the workpiece with two belt members arranged so as to avoid the punching region, and the portion of the two belt members that sandwiches the workpiece can be moved to the side of the facing platen according to the movement of the moving platen.

### Aspect 15

A punching device (100), includes: a moving platen (1) and a facing platen (2) structured to be arranged to face each other in a vertical direction or the like; moving mechanisms (3, 4) structured to cause the moving platen to move toward the facing platen; and a holding and transporting unit (14, 15) structured to move a holder (belt surface), which holds one end of a sheet-shaped workpiece (S), and to transport the workpiece to a punching region sandwiched between the moving platen and the facing platen, the punching device (100) including an airflow generating unit (170,90) structured to generate airflows (A1, A2) in a region through which the workpiece to be held and transported by the holding and transporting unit passes.

According to this, it is possible to suppress the workpiece being transported from coming into contact with the members located below or above.

The present invention can also be applied to a configuration in which a plurality of grippers are arranged on an endless chain as described in JP 2011-136394 A as a holding and transporting unit. That is, any configuration is applicable as long as one end of the sheet-shaped workpiece is held and transported by the holding and transporting unit.

### Aspect 16

In the punching device of aspect 15, the holding and transporting unit is a belt transporting device that sandwiches the workpiece between two belt members (14, 15) and transport it, and the two belt members are located outside the moving platen in the width direction, and hold the workpiece located in the punching region by sandwiching the portion protruding from the punching region.

According to this, it is configured to sandwich and transport one end of the sheet-shaped workpiece with two belt members arranged so as to avoid the punching region, and it is possible to suppress the workpiece being transported from coming into contact with the members located below or above.

### Aspect 17

In the punching device of aspect 16, the airflow generating unit is located on the upstream side in the transport direction with respect to the punching region, and the airflow toward the punching region is generated.

### Aspect 18

In the punching device of any one of aspects 15 to 17, the airflow generating unit (70) includes a lower airflow discharge port (71) that discharges the airflow below the region through which the workpiece to be held and transported by the holding and transporting unit passes.

### Aspect 19

In the punching device of aspect 18, the airflow generating unit generates an airflow (A1) from one end side to the other end side of the workpiece held by the holding and transporting unit as the airflow discharged from the lower airflow discharge port.

### Aspect 20

In the punching device of any one of aspects 15 to 19, the airflow generating unit (90) includes an upper airflow discharge port (91) that discharges the airflow above the region through which the workpiece to be held and transported by the holding and transporting unit passes.

### Aspect 21

In the punching device of aspect 20 including at least the configuration of aspect 16, the airflow generating unit generates an airflow from the upstream side to the downstream side in the transport direction as the airflow discharged from the upper airflow discharge port.

What is claimed is:

1. A punching device, comprising:
a moving platen and a facing platen structured to be vertically arranged to face each other;
a moving mechanism structured to cause the moving plate to vertically move toward the facing platen; and
a control unit structured to control the moving mechanism, wherein
the punching device punches a workpiece into a predetermined shape with a punching die attached to at least one of the moving platen and the facing platen by bringing the moving platen closer to the facing platen using the moving mechanism, and
the moving mechanism includes:
a plurality of pressurizing mechanisms structured to pressurize the moving platen toward the facing platen with a plurality of pressurizers having different positions in a horizontal direction from one another, respectively; and
a plurality of drive sources structured to drive the plurality of pressurizing mechanisms, respectively.

2. The punching device according to claim 1, wherein
the pressurizing mechanisms are eccentric rotating body drive transmission mechanisms that convert rotational movement of the drive sources into vertical movement of the moving platen by an eccentric rotating body.

3. The punching device according to claim 2, wherein
in pressurizing operation in which the pressurizing mechanisms pressurize the moving platen toward the facing platen,
the pressurizers are displaced to a stop position so as not to reach a dead center of the eccentric rotating body drive transmission mechanisms.

4. The punching device according to claim 2, wherein
the control unit limits generated torque when the drive sources are driven, and
an upper limit value of the generated torque is changed depending on a rotation position of the eccentric rotating body.

5. The punching device according to claim 1, wherein
each of the pressurizers is arranged to be located at each corner of a rectangle to be included within a region of the moving platen.

6. The punching device according to claim 1, wherein
the punching device includes a plurality of deformation amount measuring units, which measure deformation amounts of members to be deformed during pressurizing by the pressurizing mechanisms, in positions where horizontal positions are different from one another, and
the control unit controls driving of the drive sources based on measurement results of the deformation amount measuring units.

7. The punching device according to claim 6, wherein
the deformation amount measuring unit is an elongation amount measuring unit for measuring an elongation amount in a vertical direction of a holding member that holds the facing platen.

8. The punching device according to claim 1, further comprising:
a transporting unit structured to load and unload the workpiece between the moving platen and the facing platen.

9. The punching device according to claim 1, wherein
the facing platen is an upwardly fixed platen structured to be fixed to a housing of the device above the moving platen.

10. The punching device according to claim 1, wherein
a setting of a punching process is changed based on identification information of the punching die attached and control information associated with the identification information.

11. A punching method for punching a workpiece into a predetermined shape with a punching die attached to at least one of a moving platen and a facing platen by bringing the moving platen closer to the facing platen that is vertically arranged to face the moving platen, the punching method comprising:
pressurizing the moving platen toward the facing platen by a plurality of pressurizers having different positions in a horizontal direction from one another, respectively.

12. The punching method according to claim 11, wherein
the pressurizing includes converting a rotational movement of a drive source into a vertical movement of the pressurizer, and the pressurizer is displaced to a stop position so as not to reach a dead center.
